(19) United States
(12) Patent Application Publication
(10) Pub. No.: US 2013/0006882 A1
(43) Pub. Date: Jan. 3, 2013

(54) PROMOTION VIA SOCIAL CURRENCY

(76) Inventor: Giulio Galliani, Bologna (IT)

(21) Appl. No.: 13/528,018

(22) Filed: Jun. 20, 2012

Related U.S. Application Data
(60) Provisional application No. 61/568,935, filed on Dec. 9, 2011.
(60) Provisional application No. 61/529,587, filed on Aug. 31, 2011.
(60) Provisional application No. 61/498,683, filed on Jun. 20, 2011.

(51) Int. Cl. G06Q 99/00

(52) U.S. Cl. 705/319

(57) ABSTRACT

In one aspect, the present disclosure describes a method that may include determining, for presentation to a first user as a user interface at a user computing device, interface information including a number of information posts. Each information post of the number of information posts may be associated with a respective interest level. The number of information posts may be arranged for presentation in a ranked order based in part upon the respective interest level of each information post of the number of information posts. A first user account may be associated with the first user. The method may further include providing the interface information for presentation at the user computing device.

### RELATED APPLICATIONS

The present application claims priority to U.S. Provisional Application No. 61/568,935 entitled “Self-Promotion Via Social Currency” and filed Dec. 9, 2011, U.S. Provisional Application No. 61/498,683 entitled “System and Method of Self-Promotion Via Social Currency” and filed Jun. 20, 2011, and U.S. Provisional Application No. 61/529,587 entitled “System and Method of Self-Promotion Via Social Currency” and filed Aug. 31, 2011, the contents of each of which are hereby incorporated by reference in their entirety.

### BACKGROUND

Social networking through electronic means provides the opportunity for individuals to express ideas and share information. A number of web sites available through the Internet, for example, provide forums for social networking. A user, in some circumstances, may create an account at a social networking web site to gain access to sharing information with other users registered with that social networking web site.

### SUMMARY

In one aspect, the present disclosure describes a method that may include determining, by a processor of a computing device, for presentation to a first user as a user interface at a user computing device, interface information including a number of information posts. Each information post of the number of information posts may be associated with a respective interest level. The number of information posts may be arranged for presentation in a ranked order based in part upon the respective interest level of each information post of the number of information posts. A first user account may be associated with the first user. The method may further include providing the interface information for presentation at the user computing device. The method may further include receiving, via the user computing device, an indication of a user interaction associated with a first information post of the number of information posts, where the first information post may be associated with a second user account of a second user. Responsive to receiving the indication of the user interaction, the method may further include: debiting, by the processor, a first point value from a number of points associated with the first user account; crediting, by the processor, a second point value to a number of points associated with the second user account; creating, by the processor, an association between the first user account and the second user account; and adjusting, by the processor, the respective interest level associated with the first information post.

The method may further include, responsive to receiving the indication of the user interaction, crediting, by the processor, a third point value to a number of event points associated with first user account. The event points associated with the first user account may be applicable in registration for an event advertised via a web site. The first user account may be registered to the web site.

The number of information posts may include event information, and the interaction may include registration information. The method further include adjusting, by the processor, an attendance level of the first information post.

The method may further include receiving, via the user device, a first location indicator including a geographic location. The method may further include filtering, by the processor, a number of information post identifiers to select the number of information posts. Each information post identifier of the number of information post identifiers may identify a respective information post of the number of information posts. Each information post of the number of information posts may be selected based in part upon the first location indicator.

The geographic location may include at least one of a city, a metropolitan area, a state, a province, a territory, and a country.

The user interface may be associated with a first portion of a web site, and the first portion of the web site may be associated with a first topic category. The interaction may include a re-post indication including a second topic category. A second portion of the web site may be associated with the second topic category. The method may further include creating a logical link between the first information post and the second portion of the web site. The first topic category may be a sub-category of the second topic category.

The second portion of the web site may be a news room interface. The news room interface may include a number of articles, where one or more articles of the number of articles relate to one or more portions of the web site. A first article of the number of articles may include the re-post of the first information post. The first article may be associated with the second user.

The method may further include receiving, via the user device, a timeframe indicator. The method may further include filtering, by the processor, a number of information post identifiers to select the number of information posts. The number of information post identifiers may include one or more information identifiers identifying each of the number of information posts. Each information post of the number of information posts may be selected based in part on a comparison of a respective timestamp of each information post of the number of information posts to a time period associated with the timeframe indicator.

The interaction may be a response to the first information post. The method may further include determining, by the processor, for presentation as a second user interface, second interface information. The second interface information may include the first information post and a response post. The response post may include a portion of the response information. The first information post may be configured to be presented within a first column of the second user interface. The response post may be configured to be presented within a second column of the second user interface, where the second column is configured to be presented adjacent to the first column. The method may further include providing the second interface information for presentation at the user computing device.

The method may further include, responsive to receiving the indication of the user interaction, crediting, by the processor, a third point value to a number of self-promotion points associated with first user account. The self-promotion points may be associated with the first user account and may be applicable in promoting an information post including content created by the first user.

The method may further include adjusting, by the processor, a popularity level associated with the first user account. The popularity level may be based in part upon a number of associations between the first user account and one or more other user accounts.

In one aspect, the present disclosure describes a system that may include a processor, and memory storing instructions thereon. The instructions, when executed, by cause the processor to determine, for presentation to a first user as a user interface at a user computing device, interface information including a number of information posts. Each information post of the number of information posts may be associated with a respective interest level. The number of information posts may be arranged for presentation in a ranked order based in part upon the respective interest level of each information post of the number of information posts. A first user account may be associated with the first user. The instructions, when executed, may further cause the processor to provide the interface information for presentation at the user computing device. The instructions, when executed, may further cause the processor to receive, via the user computing device, an indication of a user interaction associated with a first information post of the number of information posts, where the first information post may be associated with a second user account of a second user. Responsive to receiving the indication of the user interaction, the instructions, when executed, may further cause the processor to: debit a first point value from a number of points associated with the first user account; credit a second point value to a number of points associated with the second user account; create an association between the first user account and the second user account; and adjust the respective interest level associated with the first information post.

The processor may include a number of processors in communication via a network. Creating the association between the first user account and the second user account may include adjusting a level of acquaintance between the first user a second user. The level of acquaintance may be based in part upon a number of times the first user has initiated interactions with information posts associated with the second user. The second account may be registered to the second user.

The level of acquaintance may be further based in part upon a number of times the second user has initiated interactions with information posts associated with the first user. The ranked order may be based further in part upon a respective acquaintance level between the first user and a respective user associated with each information post of the number of information posts.

In one aspect, the present disclosure describes a non-transitory computer readable medium having instructions thereon that, when executed, perform operations including: determining, for presentation to a first user as a user interface at a user computing device, interface information including a number of information posts. Each information post of the number of information posts may be associated with a respective interest level. The number of information posts may be arranged for presentation in a ranked order based in part upon the respective interest level of each information post of the number of information posts. A first user account may be associated with the first user. The instructions, when executed, may further perform operations including providing the interface information for presentation at the user computing device. The instructions, when executed, may further perform operations including receiving, via the user computing device, an indication of a user interaction associated with a first information post of the number of information posts, where the first information post may be associated with a second user account of a second user. Responsive to receiving the indication of the user interaction, the instructions, when executed, may further perform operations including: debiting a first point value from a number of points associated with the first user account; crediting a second point value to a number of points associated with the second user account; creating an association between the first user account and the second user account; and adjusting the respective interest level associated with the first information post.

The user interface may be associated with a web page of a web site. The web page may include a number of controls selectable for filtering information presented within the page. The number of controls may include two or more of a time period filter, a geographic location filter, an interest level filter, and an acquaintance level filter.

The acquaintance level filter may be configured, upon selection, to filter a number of information post identifiers to select a second number of information posts. Each information post identifier of the number of information post identifiers may be associated with the web page. The acquaintance level filter may be configured to filter the number of information post identifiers based in part upon an acquaintance level between the first user and a respective user associated with the respective information post identifier of the number of information post identifiers.

The interest level filter may be configured, upon selection, to filter a number of information post identifiers to select a second number of information posts. Each information post of the second number of information posts may be selected based in part upon the respective interest level of the respective information post. The interest level filter may be associated with a range of interest levels including the respective interest level.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIGS. 1A through 1D illustrate example user information interfaces for an application related to promotion via social currency;

FIG. 2 illustrates an example discussion room information interface for an application related to promotion via social currency;

FIGS. 3A through 3E illustrate a number of example discussion room interfaces for an application related to promotion via social currency;

FIG. 4 is a flow chart of an example method for trading social currency in an application related to promotion via social currency;

FIG. 5 is a flow chart of an example method for obtaining a location-specific discussion room interface;

FIG. 6 is a flow chart of an example method for event registration in an application related to promotion via social currency;

FIG. 7 is a flow chart of an example method for re-posting information between discussion rooms in an application related to promotion via social currency;

FIG. 8 is a flow chart of an example method for filtering information posts provided in a user interface;

FIG. 9 is a block diagram of an example network environment for promotion via social currency;

FIG. 10 is a block diagram of an example computing device and an example mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In some implementations, the present disclosure may be directed to a system and method for promotion via social currency. Social currency, for example, may refer to a credit and debit mechanism related to interactions between users interacting within a social networking web site. In some examples, upon registration with a social networking web site, a user may be credited a first quantity of social currency points, the social currency points being exchangeable for performing one or more types of interactions on the social networking web site. In some implementations, a user may be credited social currency points in relation to performing initial activities through the social networking web site. For example, upon posting information to the social networking web site, the user may be allocated a first quantity of social currency points. Further to the example, after having posted information a threshold number of times (e.g., five, ten, twenty, etc. information posts), a user may be allocated a second quantity of social currency points. The initial credit of social currency points may provide the user the opportunity to interact with information created by other users of the social networking web site. A first user, in one example, may be debited social currency points to be credited to a second user in relation to information posted to the social networking web site by the second user. The social currency, for example, may be exchanged to represent a level of appreciation a first user has for information generated by or content created by a second user. In some implementations, to promote information posted by a user, the user may allocate one or more social currency points towards boosting a level of approval associated with the information.

The social currency, in some implementations, may be used to purchase goods or services. For example, a number of social currency points may be traded to secure a reservation for an event. In another example, one or more social currency points may be traded to purchase a service or item sold, in some examples, by another user of the social networking system or by the administrative entity of the social networking system.

A particular information item posted by a first user, in some implementations, may be associated with an interest level based upon interest expressed by other users in the form of exchanging one or more social currency points to promote the particular information item. For example, if a second user is highly entertained by a story or media item posted by the first user, the second user may allot one or more social currency points towards that particular information item, thus increasing the interest level of the particular information item. Consequently, in some examples, the particular information item may be promoted in rank among other information items displayed in a particular portion of the social networking web site based in part upon an increased interest level due to the allocation of social currency points by the second user.

In some implementations, upon exchange of social currency points between a first user and a second user, an acquaintance may be established between the first user and the second user. In an ongoing manner, as social currency points are traded between the first user and the second user, an acquaintance level between the first user and the second user may be adjusted by the system. For example, based in part upon the acquaintance level between the first user and the second user, information provided by the second user may be promoted to the first user by the system. In a particular example, the system may draw the attention of the first user to information recently posted by the second user using a ranking system for information presentation based in part upon acquaintance level. In some implementations, the popularity level of a user may be based in part upon a number of acquaintances between the user and other users of the social networking web site. The popularity level of the user, in some implementations, may be further based in part upon a relative acquaintance level of each of the acquaintances between the user and other users of the social networking web site.

The social networking web site, in some implementations, may be divided into a number of discussion rooms where each discussion room may be associated with a certain topic or topic category including, but not limited to, hobbies, interests, organizations, individuals, vocations, and events. A discussion room, in some implementations, may be created by a user of the social networking web site. For example, a user may be presented with a discussion room creation web page including information fields regarding a discussion room name and a description of the topic of content to be shared in the discussion room. In some implementations, a user may be provided an opportunity to specify a level of privacy of a discussion room. For example, a public discussion room may allow all registered users of the social networking web site to review and interact with, and add information to, the discussion room. A private discussion room, in one example may require a membership prior to being allowed to interact with or add information to the discussion room, while non-members may be provided the opportunity to review a portion of the information provided in the discussion room. In some implementations, a private discussion room may be closed to non-members. Prior to creation of the new discussion room, in some implementations, a site administrator or other authority may review the request submitted by the user.

In some implementations, two or more discussion rooms may be hierarchically related. For example, a first discussion room regarding pop music may be related to a second discussion room regarding a particular pop music star. The discussion rooms, in some implementations, may be searchable by topic and/or by geographic location.

In some implementations, the user may indicate a position in existing discussion room hierarchy to place the new discussion room. For example, a room may be a sub-room of another room. If, in a particular example, a wild salmon discussion room already exists as part of the social networking web site, a wild salmon migration room may be positioned as a sub-room of the wild salmon room.

In some implementations, a site administrator or other authority may coordinate the structure and hierarchy of discussion rooms. For example, a site administrator may merge two or more discussion rooms together, delete a discussion room, or alter a position of a discussion room within the hierarchy of a topic. Upon review of the request to create a new discussion room, for example, the site administrator may propose an alternate topic area or alternate hierarchical position within a topic area to the requestor.

In some implementations, a sub-room of a discussion room may include an inheritance structure in relation to information posted within the room. In some examples, information posted within a sub-room may also be presented within the parent room. Conversely, information posted to a parent room or a sibling room (e.g., an additional sub-room of the same parent room) may, in some examples, fail to be presented within the aforementioned sub-room. In some implementations, whether information is automatically presented in a parent room when posted to a sub-room may be based on individual settings applied to the particular discussion rooms. For example, although a Harvard University room may be considered a sub-room of a Boston area colleges room, the creator or administrator of the Harvard University room may not wish for the information posted to the Harvard University room to be shared with those visiting the Boston area colleges room.

In some implementations, one or more discussion rooms or portions of information posted to a particular discussion room may be considered private (e.g., shared with authorized users only). For example, a particular club, corporation, college department, or other private organization may initiate a members-only discussion room within the social networking web site.

In some implementations, two or more users may engage in a closed conversation. For example, one or more “private” posts may be exchanged within a collection of pre-approved users. In some implementations, to review “private” posts, a user may visit a section of his or her room (e.g., home page).

To communicate in a discussion room, in some implementations, a user may select a control to create a new post. In some examples, a post may contain one or more information items such a text, graphics, video, audio, and virtual links (e.g., hyperlink) to additional information. Additionally, in some examples, a user may select to post a response to an existing post. For example, a user may select a particular post and be presented with a control to create a reply to the currently selected post.

Within a discussion room, in some implementations, information may be presented in a multi-column format. For example, upon entering a discussion room, in some examples, a left hand column may initially list a vertical series of posts or thoughts, where individual posts may have been generated by one or more users of the social networking site. Upon selection of a particular post (e.g., mouse click, double-click, touch of a touch screen, mouse-over, voice-activated select command, etc.), any responses posted in relation to that post may be displayed in a right hand column. Further to the example, if the user selects one of the posts displayed in the right hand column (e.g., the responses to the selected post), in some implementations, the selected response may replace the information within the left hand column, while any responses posted to that particular response may be presented in the right hand column. In other implementations, an additional (e.g., third) column may be added to the display interface to display any responses posted to that particular response. In this manner, in some implementations, any number of columns may be included to identify multiple layers of responses to information items. In the event that the number of columns extends beyond a viewable region, in some implementations, a scroll bar may be included to provide the user with a method for navigating through the various levels of responses.

Within this format, in some implementations, when a user selects an original (e.g., first generated in a series, hierarchically leading, etc.) post or a post which is a response to an original post, a response field may be presented to the user adjacent to the selected post (e.g., beneath, abutting, partially overlapping, to the side of, etc.). The user may, for example, opt to post a response to the selected post by inputting information within the response field. The information added to the response field, in some examples, may include any type of information (e.g., text, audio, graphic, video, virtual link, etc.) or a combination thereof. Once a user has posted a response, in some implementations, the response may be presented in the right-hand column among any other responses previously posted to the selected post.

In some implementations, a user may be provided the option to re-post an information item, originally posted in a first discussion room, to a second discussion room. For example, if a user believes that information posted to the discussion room dedicated to Chicago live music would be of interest to readers of the discussion room dedicated to Chicago blues musicians, the user may select to re-post the information to the Chicago blues musician discussion room. In an example, the system may create a virtual link to the original post such that the information item is stored only once by the system. If, instead, the user attempted creating a new post containing the same information item or to re-post an information item within the same discussion room, in some implementations, the system may recognize the post as a duplicate and block the creation of the new post.

In some implementations, a user may be provided a control associated with an information item for flagging the information item as being abusive or inappropriate. For example, a user may flag an item as being inappropriate due to obscenity, pornographic material, spam, hateful or discriminatory content, or content not related to the topic of a particular discussion room. In some implementations, a site administrator may review flagged content to determine whether to take action related to the content. For example, a site administrator may identify an information item as being inappropriate, abusive, or off-topic. An information item identified by the administrator, in some implementations, may be deleted from the social networking web site. In some implementations, rather than deleting the information item, the identified information item may be obscured (e.g., pixilated, overlaid with a semi-opaque censoring image, filtered through a digital image filter to add noise or blurring, etc.) to inhibit further review of the information item, while statistics associated with the information item (e.g., interest level, etc.) or one or more responses posted in relation to the information item may remain visible for users' review. In some implementations, additional information may be identified in relation to an obscured information item such as, in some examples, a number of times flagged by users as inappropriate material, a category of inappropriate material, or a penalty applied to the account of the user who originated the information item.

In some implementations, social currency points may be deducted from an account associated with the user who generated the flagged information item. For example, a user may be penalized a number of social currency points for posting inappropriate material. In some implementations, a number of social currency points deducted from the account of a user may depend in part upon the type of material posted (e.g., spam may be penalized at a different level than obscenity, etc.), the number of times the particular user has been flagged as posting inappropriate content (e.g., a higher penalty may be allocated to second offense than to first offense), and/or the type of information item (e.g., a different penalty for the user who generated the content than to the user who re-posted the content, etc.). In some implementations, the penalty may be identified in relation to the removed or obscured information item, for example as an alert to other users regarding the consequences of abusing the environment of the social networking system.

In some implementations, other penalties may be attached to a user account related to inappropriate content in user-generated information items. In some examples, a user may be banned from posting information items to the social networking site for a period of time, banned from posting information items to a particular room of the social networking site for a period of time, removed from the member list of a private or semi-private discussion room, and/or demoted in popularity level (e.g., on a site-wide or discussion room basis).

Upon re-posting, in some implementations, a re-post value may be debited from the user who opts to re-post the information. Further to this example, in some implementations, the user who originated the post (e.g., if not the same user who is performing the re-posting operation) may be credited one or more social currency points related to the re-posting of the information item.

In some implementations, a user may apply a geographic location to an information item when submitting an information item to a discussion room. For example, if a certain pop music star were appearing in Atlanta, a user may submit an information item regarding the pop music star's appearance to a discussion room dedicated to the pop music star and associate the information item with the geographic location of Atlanta, Ga.

A user visiting a discussion room, in some implementations, may apply a geographic location to filter the information presented within the discussion room. For example, the user may apply the geographic location of Georgia to the pop music star discussion room, thus filtering the information items presented to those associated with the state of Georgia or a geographic location within the state of Georgia. The system, for example, may generate a “virtual discussion room” including only Georgia-based information items related to the pop music star based upon the application of the geographic location.

In addition to information items presented for discussion, in some implementations, one or more discussion rooms may include an events portion pertaining to events associated with the topic or topic category of the discussion room. The events may be calendar events held at a physical geographic location, such as a concert, meeting, musical performance, or symposium.

In some implementations, a user may create an event listing by posting information associated with a time and location. In some examples, the event listing may further include a price in social currency points for registration. For example, a user signing up to attend a meeting at a local college to discuss recent events in the community may incur a registration cost of fifteen social currency points.

A particular event posted by a first user, in some implementations, may be associated with an interest level based in part upon the number of users registered to attend the event. For example, if two or more events are scheduled for a particular calendar period (e.g., day, week, month, etc.), rather than displaying events in the order in which they were added to the system, in some implementations the events may be ordered based in part upon the number of users registered to attend the event.

In some implementations, the interest level of individual event listings may further be influenced by the relative value of each event (e.g., the cost of registration). Consequently, in some examples, an event listing may be promoted in rank among other events displayed in a particular calendar period in an events portion of the social networking web site based in part upon an increased interest level due to the allocation of social currency points by registered users. In some implementations, an event listing may be promoted in rank among other events displayed in a particular calendar period based in part upon a ratio of the number of registered participants to the cost of registration or, conversely, the ratio of the cost of registration to the number of registered participants.

In some implementations, rather than being allocated a single pool of social currency points, a user may be allocated both social currency points usable towards virtual interactions via the social networking site (e.g., through discussion rooms) as well as separately accounted social currency points usable towards registering for events taking place in a geographic location. In an example, social currency points may be credited to both the virtual interaction account and the events registration account of a first user when a second user applies social currency towards information (e.g., discussion room posting, event listing, etc.) originated by the first user. In some implementations, a certain number N of social currency points may be accrued towards the virtual interaction account prior to a point accruing within the events registration account. For example, for every five, ten, twenty, twenty-five, etc. social currency points, a user may be allotted one events registration point.

In some implementations, a user may allocate social currency points towards information posted by that user. In this circumstance, the user may promote information that the user wishes to draw to the attention of other users of the social networking web site. In some implementations, a third category of points may be allocated for use in self promotion. For example, self-promotion points may be allocated to a user for each N points (e.g., five, ten, twenty, etc.) credited to the user in relation to an interaction with user-generated content by an other user of the social networking system. For example, upon receipt of twenty-five social currency points credited in response to one or more promotions, re-postings, or approvals of user-generated content, the user may be credited one self-promotion point to be allocated towards boosting the approval rating of a self-generated information item.

In some implementations, a discussion room may include privacy settings, limiting a portion or all of the information contained within the discussion room to a select group of users. In some examples, a social club, employee organization, or other membership organization may limit access to a portion of a discussion room to members only. In some examples, a discussion room may be fully private (e.g., password protected and by invitation only) or partially private (e.g., non-members may view a portion of the information available in the discussion room but may not be allowed to originate posts or events).

In some implementations, the privacy settings on a discussion room may effect the operation of active and passive re-posting of information. For example, although the discussion room of a private charitable organization may be hierarchically positioned as a sub-room of a charitable topic (e.g., lupus awareness, etc.), the postings within the private discussion room may not be automatically re-posted within the parent discussion room. If, in another example, a user attempts to re-post information posted to a private discussion room, the user may be blocked from doing so based upon privacy settings.

Events posted to a private discussion room, in some implementations, may include both private and public events. For example, monthly member meetings may be posted as private events, while a fundraiser for a private charitable organization may be posted as a public event. Opportunity to register for an event, in these examples, may depend upon privacy settings applied to individual events.

In some implementations, in addition to a hierarchical collection of discussion rooms, the social networking web site may include one or more news room interfaces where users may present information regarding the activities of a particular discussion room or grouping of discussion rooms (e.g., discussion rooms arranged in a hierarchy, or discussion rooms encompassing an overarching theme). The information presented in a news room interface, for example, may be similar to newspaper articles, where each article addresses recent activity within one or more discussion rooms. The news room interfaces, in some examples, may be universal (e.g., a single news room interface), topic or category related (e.g., articles pertaining to any sports-related discussion boards, any politics-related discussion boards, etc.), or geographically-relevant (e.g., a Canada-based news room interface, a France-based news room interface, etc.). In some implementations, an information post from a particular discussion room may be re-posted within a news room interface.

In some implementations, a user may be delivered a news room interface based upon filter specifications supplied by the user. For example, a user may specify one or more topics of interest (e.g., baseball, U.S. politics, and interior decorating). Articles, in this example, may be filtered for keywords or filtered based on article settings. For example, an article may be actively associated with topics and sub-topics upon submission (e.g., through an article submission user interface).

Presentation of articles within the news room interface, in some implementations, may depend in part upon a respective interest level of each article. For example, users may have the opportunity to apply approvals and disapprovals to articles in a similar manner to discussion room posts. In this manner, the most interesting articles may be promoted to key positions within the news room interface.

A user wishing to post an article to a news room, in some implementations, may first need to obtain clearance for posting the article. For example, the user may require a certain site-wide popularity level or popularity level within the discussion room(s) promoted within the article to be allowed to post the article.

In some implementations, articles submitted to a news room interface may be reviewed by an administrator prior to being added to the news room. For example, a user may submit an article for review by an administrator or administrative body which may review the article for content and style prior to posting the article to the targeted news room interface.

In some implementations, a user may be charged a number of social currency points to be allowed to post an article within a news room interface. For example, a user may be charged a flat fee or a fee (e.g., number of points) depending upon the article scope (e.g., article length, number of discussion rooms mentioned within the article, etc.).

In some implementations, a user may pay a larger posting fee to post an article in a prime location within a news room interface. For example, if the originator/administrator of a new discussion room wishes to promote the discussion room via the news room interface, the originator/administrator may choose to pay a premium fee for prime positioning of the article within the news room interface. In a particular example, paying a prime posting fee may translate to artificially adding interest points to an article, increasing the ranking of the article within the news room.

Rather than or in addition to charging social currency points for posting an article, in some implementations, a user may pay a monetary fee for posting an article. For example, in order to promote an article to a prime position for advertising purposes, a user may pay a monetary fee for one of a handful of prime article positions within the news room interface. Similarly, in some implementations, a monetary fee may be charged for re-posting an information item into a news room. Payment for promotion of a discussion room, for example, may be used as a mechanism for offsetting the costs of running the social networking web site.

In some implementations, the news room may be filtered to present a geographically-relevant news room. For example, users may post one or more articles containing information pertaining to a particular geographic location (e.g., an article discussing a number of dining and entertainment related discussion rooms in the Denver, Colo. area). Upon submitting the article to the news room, for example, the poster may be presented with the option to select a geographic location or region to associate with the article.

Although described in relation to discussion room information, reviews of social events and promotional information pertaining to upcoming social events may also be submitted, in some implementations, to a news room interface. For example, a user may submit an article describing recent activities of a local club to increase interest in other users towards attending a social event at a physical location hosted by the local club.

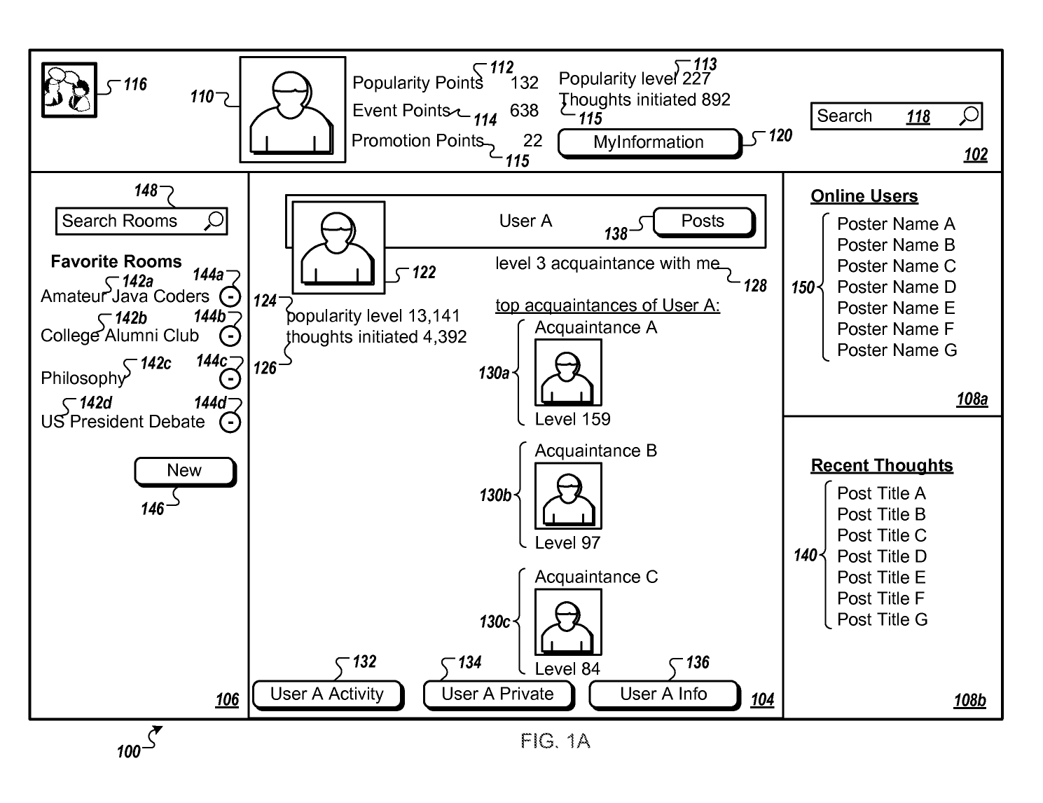

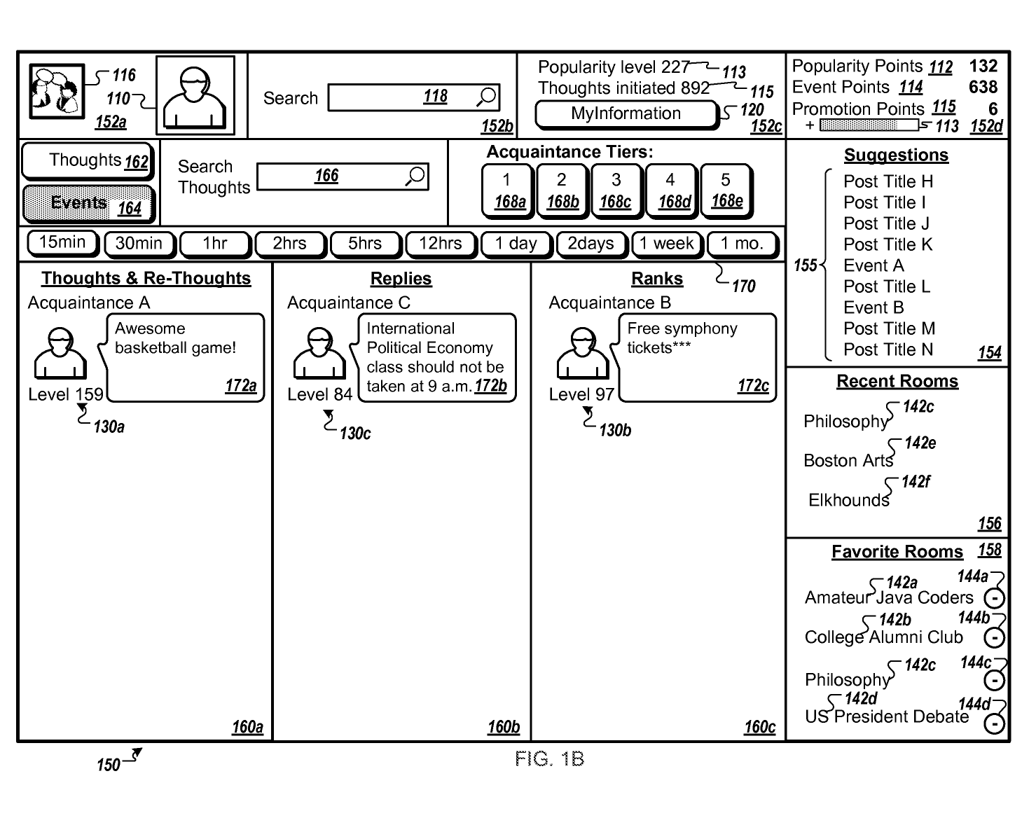

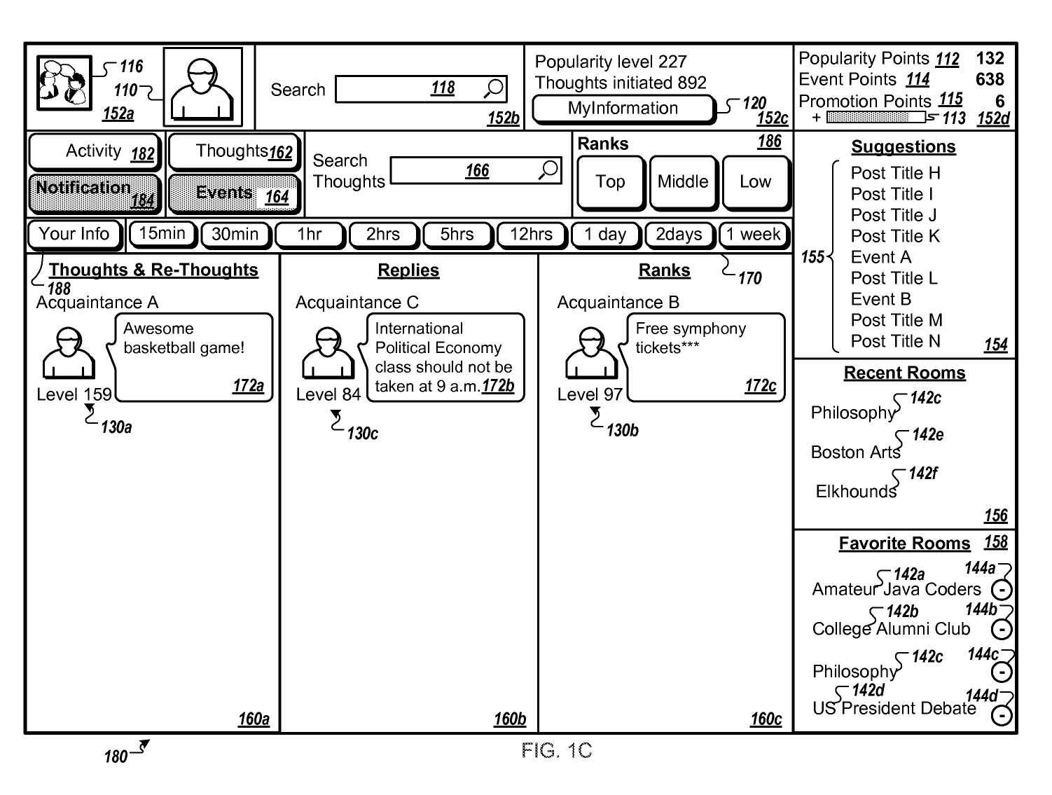

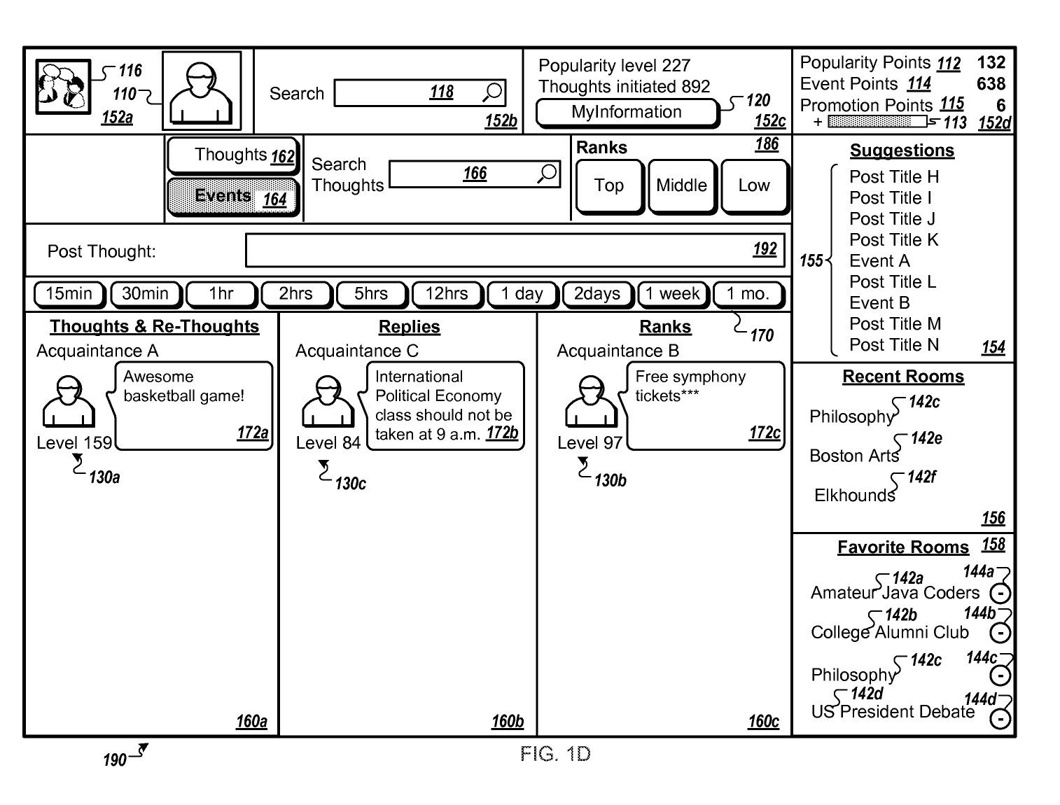

FIGS. 1A through 1D illustrate various user interfaces for an application related to promotion via social currency. In some implementations, the user interfaces presented within FIGS. 1A through 1D may represent various initial views a user may access to interact with information items posted within a social networking web site. Referring now to FIG. 1A, a user interface 100 for an application related to promotion via social currency may include a menu bar 102 containing, for example, general navigation information presented to a registered user of the social networking site, a main panel 104 containing, for example, information regarding a second registered user of the social networking site, a left panel 106 containing, for example, discussion room navigation information, and a right panel 108 containing, for example, information on recent activity of the social networking site. In some implementations, the user interface 100 may be presented to a registered user upon request of information pertaining to a particular user (e.g., “User A”) of the social networking site.

As illustrated in the menu bar 102, in some implementations, a logo 116 of the social networking web site may be illustrated in the left corner. In some implementations, a user may upload a user image 110. A search field 118 on the right side of the menu bar 102, for example, may allow the user to search for content in the social networking web site. In some examples, the content may include a discussion room, an information item (e.g., a user post or portion thereof), an event, or a registered user. The various content available via the social networking web site, for example, is discussed in more detail below.

Next to the user image 110, a popularity points balance 112 (e.g., of one hundred thirty-two points), an event points balance 114 (e.g., of six hundred and thirty-eight points), and a self-promotion points balance 115 may be presented. In some examples, a registered user account may be associated with a popularity points account containing the popularity points balance 112, a self-promotion points account containing the self-promotion points balance 115, and an event points account containing the event points balance 114. The popularity points balance 112, in some implementations, may be exchanged as a gesture of appreciation for content generated by another user of the social networking web site. For example, one or more popularity points may be debited from the popularity points balance 112 when the user selects a control approving content presented by another user. The user, conversely, may accumulate points in the popularity points balance 112 by being credited for approvals obtained through content generated by the user.

In some implementations, self-promotion points 115 may be allocated to a user for each N points (e.g., five, ten, twenty, etc.) credited to the user in relation to an interaction with user-generated content by an other user of the social networking system. For example, upon receipt of twenty-five social currency points credited in response to one or more promotions, re-postings, or approvals of user-generated content, the user may be credited one self-promotion point 115 to be allocated towards boosting the approval rating of a self-generated information item. In this circumstance, the user may promote information that the user wishes to draw to the attention of other users of the social networking web site. The promotion points balance, in some implementations, may refer to a portion of the popularity points balance available for use in self-promotion. In other implementations, rather than separate accounts, the popularity points 112 may be available to the user for either self-promotion or for providing approvals or otherwise interacting with content generated by other users of the social networking system.

In some implementations, a certain number N of popularity points 112 may be accrued prior to accruing events points 114. For example, for every five, ten, twenty, twenty-five, etc. popularity points 112, a user may be allotted one events point 114. In this manner, to have the opportunity to register for in-person events, a user may first need to prove to be active within the virtual community.

In some implementations, while interacting within the virtual community, a user may accrue a popularity level 113 (e.g., illustrated as 227). In some implementations, the popularity level may reflect, in part, a number of acquaintances between the user 110 and other users of the social networking web site. The popularity level 227, in some implementations, may be based further in part upon a level of acquaintance between the user and one or more users of the social networking web site. For example, the social networking web site may track interactions (e.g., promotion of events and/or content generated by others) between users of the web site and, based on these interactions, calculate popularity levels for each of the users. In some implementations, the popularity level 113 may be based in part upon a number of times a different user of the social networking web site has promoted content generated by a particular user (e.g. the user referenced by the image 110). In some implementations, the popularity level 113 may be based in part upon a number of times the user viewing the interface 100 has promoted content generated by another user of the social networking web site.

Beneath the popularity level 113, a number of thoughts initiated 115 (e.g., 892) is listed. The thoughts initiated 115, for example, may reflect the number of information posts or other user content generated by the user viewing the interface 100. The popularity level 113, in some implementations, may reflect, in part, the number of times other users have promoted one or more of the thoughts initiated 115 by the user.

A user may select a MyInformation control 120, in some implementations, to access user account information. For example, much of the information presented upon selection of the MyInformation control 120 may be similar to the information presented in the main panel 104, which as illustrated describes another user of the social networking web site. Upon selection of the MyInformation control 120, in some examples, the user may be provided access to modify information that is publicly presented to users of the social networking web site. In some examples, the user image 110, a user location, and other demographic details may be modified by the user through the MyInformation control 120.

In some implementations, selection of the MyInformation control 120 may present the user with a user-centric view of the social networking web site, such as a home page. For example, upon selection of the MyInformation control 120, the user may be presented with a user interface similar to the interface 180 illustrated in FIG. 1C.

As illustrated in the main panel 104, an image 122 associated with user “User A” may be presented in an upper left-hand corner above a user popularity level 124 (e.g., thirteen thousand, one hundred forty-one) and a number of thoughts initiated 126 (e.g., four thousand, three hundred and ninety-two). In some implementations, the popularity level 124 of the user may be determined in relation to other users of the social networking web site. In some implementations, the popularity level 124 of the user may be determined in part by a number of acquaintances between the user and other users of the social networking web site. The popularity level 124, in a particular example, may be based on both the number of acquaintances between the user and other users of the social networking web site and an acquaintance level associated with each of the number of acquaintances. In some implementations, the user popularity level 124 may be based in part upon the number of approvals the user has obtained since joining the social networking web site. For example, the total number of popularity points ever acquired by the user as credits based upon points allocations made by other users of the social networking web site may be considered in determining the popularity level 124 of the user. In a particular example, the user popularity level 124 may be determined by adding the total number of approvals received by the user to the total number of approvals provided by the user to information items posted by other users. In some implementations, when a user posts an information item or a response to an information item, the information item may receive a “rank boost” based upon the popularity level of the user. For example, the information item with a rank boost may be promoted in position upon display (relative to the same information item without a rank boost) to other users based in part upon the popularity level of the posting user. By boosting the position of an information item upon initial posting based upon the popularity level of the posting user, for example, the information item may be promoted above new information items posted by users with lower popularity levels.

In some implementations, rather than an overall popularity level, the popularity level 124 may reflect a level of approval obtained through interactions in a particular discussion room, or a number of acquaintances between a user and other users who have participated in the particular discussion room. The popularity level of User A with respect to a robotic hobbyists discussion room, for example, may be based upon a number of approvals exchanged between User A and other users within the construct of the robotic hobbyists discussion room. In another example, the popularity level of User A with respect to the robotic hobbyists discussion room may be based upon a number of acquaintances made between User A and other users while contributing to the robotic hobbyists discussion room. Further to this example, the popularity level of User A with respect to the robotic hobbyists discussion room may be based in part upon a level of acquaintance between User A and the various other users who have interacted with User A through the robotic hobbyists discussion room.

In some implementations, a particular user may be associated with any number of popularity levels, each popularity level reflecting a level of popularity with respect to a particular discussion room. For example, User A may have a first popularity level in relation to a robotics hobbyists discussion room, a second popularity level in relation to a country music discussion room, and a third popularity level in relation to a women's basketball discussion room. The various popularity levels, in this example, may depend in part upon the level of expertise or level of interest User A has in the various topics (e.g., hobby robotics, country music, and women's basketball). For example, User A may provide expert advice in building household robots through the robotic hobbyists discussion room, gaining User A a large number of approvals from other users who have benefited from the knowledge provided by User A. Conversely, User A may enjoy submitting a comment from time to time regarding women's basketball, but may not garner a great deal of approvals either due to a low number of posts initiated or due to the information provided by User A being rarely of interest to other users of the social networking web site. In some implementations, the popularity level 124 may refer to the highest popularity level held by User A in any discussion room.

The main panel 104, in some implementations, may list various acquaintance levels between User A and other users of the social networking web site. For example, a personal acquaintance level 128 of three (e.g., “level 3 acquaintance with me”, as illustrated in FIG. 1A) may be presented as the level of acquaintance between User A and the user being presented the user interface 100. When a first user provides approval, for example in the form of popularity points, to a second user, in some implementations, an acquaintance may be established between the first user and the second user. An acquaintance level may subsequently be derived through repeated interactions between the first user and the second user. For example, the personal acquaintance level 128 of the user in relation to User A may be based in part upon a number of approvals provided by User A to the user, a number of approvals provided by the user to User A, or a combination thereof.

Acquaintance level, in some implementations, may be derived relative to other acquaintance interactions being tracked within the social networking web site. For example, the personal acquaintance level 128 may be relative to other acquaintances of the user or relative to average or mean acquaintance levels established in general by users of the social networking web site. In a particular example, the acquaintance level may refer to the sum of the approvals both from the first user to the second user and to the second user by the first user.

In some implementations, the main panel 104 may include a number of top acquaintances 130 of User A. For example, a first acquaintance 130a may be presented as an acquaintance name, associated graphic, and acquaintance level (e.g., one hundred fifty-nine). Any number of acquaintances, for example, may be listed in the main panel 104.

In some implementations, the number of top acquaintances 130 may be illustrated in descending order of acquaintance. For example, the first acquaintance 130a has a higher acquaintance level with User A than a second acquaintance 130b (e.g., one hundred fifty-nine versus ninety-seven). In some implementations, a user may be provided with two or more options regarding the display of acquaintances. For example, a user may have the opportunity to list acquaintances based upon a total of approvals (e.g., both given by the user to the acquaintance and vice-versa), by approvals received by the user from the acquaintance, or by approvals provided by the user to the acquaintance. Other custom settings, in some implementations, may be available to a user in relation to display of information within the user interface 100.

In some implementations, the various metrics determined by the system (e.g., acquaintance level, popularity level, popularity point award, interest level, etc.) may be all or partially determined according to proprietary methods and/or algorithms. In some implementations, the user may be unaware regarding the methodology behind the calculation of one or more of the aforementioned metrics. For example, a proprietary method for determining one or more of the acquaintance level, popularity level, popularity point award, or interest level may be based in part upon one or more of user profile information, user demographic information, user behavior information, discussion room specific metrics, discussion topic specific metrics, or other information tracked and quantified by the system. In one example, a metric such as acquaintance level, popularity level, popularity point award, and interest level, may be based in part upon an objective component (e.g., such as algorithms described in relation to the calculation of each of the aforementioned metrics) and further in part upon a subjective component (e.g., user profile information, user demographic information, user behavior information, discussion room specific metrics, discussion topic specific metrics, etc.).

In some implementations, selection of a portion of the information presented in relation to one of the top acquaintances 130 may result in the presentation to the user of similar information as presented in the main panel 104, but in relation to the selected user. For example, upon selection of the graphic representing a third acquaintance 130c, the user may be presented with information regarding and focusing on the third acquaintance 130c within the main panel 104.

In some implementations, upon selection of the graphic representing the third acquaintance 130c, the user may instead be presented with a listing of recent activity of the third acquaintance 130c. For example, as illustrated in a lower portion 108b of the right panel 108, a listing of recent thoughts 140 may present links to one or more posts and/or event listings initiated by a user (e.g., the user viewing the user interface 100 in the circumstance illustrated). In some examples, the listing of recent thoughts 140 may include a snippet of each individual thought (e.g., discussion post or event listing). Upon mouse-over or hover upon a particular thought in the listing of recent thoughts 140, in some examples, a portion of the discussion room posting or other information regarding the particular thought (e.g., associated discussion room, time stamp, approval level, etc.) may be presented to the user.

In some implementations, the listing of recent thoughts 140 may be grouped, e.g., by discussion room, discussion room category, acquaintance level, etc. The groups, in some examples, may be divided by color, style, dividing line, or a combination thereof. In addition to original posts, in an example, responses to one or more posts may be listed within the listing of recent thoughts 140.

In the event that User A is viewing the user interface 100 (e.g., a user home page is displayed), in some implementations, the recent thoughts 140 may include a collection of posts arranged in order, in part, based upon an acquaintance level between the poster of the respective thought and User A. For example, upon visiting a user home page, posts of interest to the user may be presented to the user viewing the home page (e.g., by acquaintance level, by favorite discussion rooms, by most visited discussion rooms, by popularity level in recently visited discussion rooms, or a combination thereof, etc.).

Returning to the main panel 104, a posts control 138, upon selection, in some implementations may provide the user with a listing of recent posts initiated by User A (e.g., discussion room thoughts, events, etc.). The listing of posts, for example, may be similar to the recent thoughts 140 illustrated in the lower portion 108b of the right panel 108.

At the bottom of the main panel 104, in some implementations, the user may be presented with an activity control 132, a private control 134, and an information control 136, each related to the presented user (e.g., User A). For example, upon selection of the activity control 132, the user may be presented with a history of the activity of User A, such as posts initiated by User A, posts approved by User A, posts in which User A is mentioned (e.g., by linking the post to the profile of User A), and events that User A created or registered to attend.

In some implementations, a portion of the historical information may include detail information such as a number of users or one or more lists of users who have approved the posts of User A and a listing users who registered for each of the events created by User A. The detail information, for example, may be available upon expansion of information regarding a post of interest to the viewing user.

Similar to posts within a discussion room, in some implementations, the information presented upon selection of the activity control 132 may be organized in a modified timeline based upon considerations such as approval rating, estimated interest level to the user viewing the information (e.g., including promotion of posts made in rooms the viewing user has visited, promotion of posts to which the viewing user responded, etc.). In an example, information may be organized by timestamp.

In the event that User A is viewing his or her own recent activity (e.g., the activity control 132 may be labeled with “My Activity”, accessible from a “home page” section of the social networking web site similar to the information presented in the user interface 100), the information presented upon selection of the activity control 132, in some implementations, may include the number of or a listing of responses made to a post since User A either initiated the post or last reviewed activity within a post that User A initiated (e.g., including initiation of a response to another user's initiated post) as well as, in an example, a total number of responses made to the particular post. In an example, the information may include the number of users who approved a particular post initiated by User A since User A last viewed the post, as well as a total number of approvals. In one example, selection of a “latest” control next to a post may provide a subset of activity containing only such information that was posted since the user last visited that particular post. Selection of a “suppress” control next to a post, for example, may cause the cessation of notifications regarding that particular post from being presented to the user within the My Activity section of the user's home page.

Returning to the bottom of the main panel 104, in some implementations, the user may select the private control 134 to access a portion of the social networking web site providing the ability to post “private” messages to other users of the social networking web site. In some examples, private posts may not be associated with popularity points. In one example, a private post may be shared with a select group of users. For example, the viewing user may select the private control 134 to post a private message to User A or to User A plus one or more additional users registered to the social networking web site.

Continuing to the right, the information control 136 at the bottom of the main panel 104, in some implementations, may provide a more detailed view of information regarding User A. In some examples, the information may include: the popularity level of User A; the number of approvals received by User A; the number of disapprovals received by User A; the acquaintance level the viewing user shares with User A; a mission statement written by User A; a registration date when User A joined the social networking web site; a membership level User A has within the social networking web site or within select discussion rooms of the social networking web site; a list of User A's favorite rooms (including, for example, activity level per room such as number of posts initiated in the discussion room, number of replies posted in the discussion room, and overall number of approvals and/or disapprovals User A received in the discussion room); and a list of acquaintances of User A.

In some implementations, the information control 136 provides access to demographic information regarding User A such as, in some examples, a home location, career information and/or business location, relationship status, hobbies, interests, education information, age, birth date, race, religion, languages spoken, telephone number, and email address.

Turning to an upper portion 108a of the right panel 108, a listing of online users 150, in some implementations, may include identifiers pertaining to one or more registered users of the social networking web site which are currently logged into the web site. In some examples, the listing of online users 150 may be selected and/or listed in ranked order based, in part, upon one or more of an acquaintance level with the user viewing the user interface 100, relative popularity level of the online users 150, and estimated interest level of the user viewing the user interface 100 with content recently generated by each user of the listing of online users 150.

As illustrated in the left panel 106, in some implementations, a list of favorite discussion rooms 142 may include an amateur java coders discussion room 142a, a college alumni club discussion room 142b, a philosophy discussion room 142c, and a U.S. Presidential debate discussion room 142d. In one example, selection of one of the discussion rooms 142 may result in presentation to the user of a discussion room user interface. The discussion rooms 142, in some examples, may be organized in alphabetical order, order of popularity level of the viewing user within the respective discussion room, order of frequency of visit of the viewing user, or a combination thereof. Next to each of the discussion rooms 142, a delete control 144, for example, may provide the viewing user with the opportunity to remove one or more favorite discussion rooms 142. In some implementations, the user may be provided with a mechanism for altering the order in which the favorite rooms are displayed. For example, upon selecting and moving one of the favorite discussion rooms 142, the user may be able to modify the order in which the favorite discussion rooms 142 are presented. A new control 146 may, upon selection, present the viewing user with the opportunity to add a discussion room to the list of favorite discussion rooms 142 (e.g., through a drop-down selection, text input field, etc.).

In some implementations, the viewing user may use a discussion room search field 148 to locate a discussion room (e.g., by name, category, user who initiated the discussion room, key word(s) used in posts in the discussion room, etc.). In a discussion room search results list, for example, each room listed may include a discussion room addition control, for example visualized with a plus sign, allowing the user to add a discussion room to the list of favorite discussion rooms 142.

Turning to FIG. 1B, a user interface 150, in some implementations, may represent an example user page presented to a user, for example, when accessing information regarding another user of the social networking web site. Similar to information contained within the user interface 100, the user interface 150 may include a menu bar 152 containing, in some examples, the logo 116, user image 110, search field 118, popularity level 113, thoughts initiated 115, MyInformation control 120, popularity points balance 112, self-promotion points balance 115, and event points balance 114. The popularity level 113, thoughts initiated 115, and points balances 112, 114, 115, in some implementations, may represent information related to the user viewing the user interface 150.

Beneath the points balances 112, 114, and 115, in some implementations, a status bar 113 may present the user with a progress towards a next allocation of one or more self-promotion points 115. For example, if a promotion point 115 is allocated for every five popularity points 112, the status bar 113 may illustrate a percentage progress (e.g., fourth-fifths) towards a next allocation of a promotion point to the promotion points 115.

In some implementations, the status bar 113 may present the user with a progress towards a next allocation of one or more event points 114. For example, if an event point 114 is allocated for every five popularity points 112, the status bar 113 may illustrate a percentage progress (e.g., fourth-fifths) towards a next allocation of an event point to the events points 114. In some implementations, events points 114 and promotion points 115 may accrue on a similar schedule. For example, the status bar 113 may apply to the accrual of both event points 114 and self-promotion points 115. In some implementations, a separate status bar (not illustrated) may be supplied to illustrate accrual related to event points 114.

Along a right column, beneath the status bar 113, a number of navigational options may be presented to a user. In some implementations, a suggested information pane 154 may include a number of recommended information items 155 such as information posts and/or events. The recommended information items 155, in some implementations, may include information items of interest to at least one acquaintance of the user. In some implementations, the recommended information items 155 may include one or more information posts and/or events that are most recent and/or have a highest interest level within favorite rooms of the user. The recommended information items 155, in some implementations, may include news rooms, discussion rooms, users, or other items that may be of interest to the user. For example, if another user is an acquaintance of a number of acquaintances of the user, the other user may be presented in the suggested information pane 154. In some implementations, the recommended information items 155 may be selected in part through direct or indirect guidance of a site administrator. For example, a site administrator may select one or more related discussion rooms to propose to the users of a particular discussion room. The site administrator, in another example, may establish key words to be used in determining one or more related discussion rooms. Other influence by the site administrator is possible.

Beneath the suggested information pane 154, in some implementations, a recent rooms pane 156 may list one or more discussion rooms 142 that the user visited. In some implementations, the recent rooms pane 156 may include rooms visited by a user within a certain period of time such as, in some examples, the last day, last three days, or last week. The recent rooms pane 156, in some implementations, may list the most recent N rooms visited by the user, regardless of how recent the visit.

In some implementations, a favorite rooms pane 158 may be presented beneath the recent rooms pane 156. The favorite rooms pane 158, similar to discussion room navigation elements described in relation to the left pane 106 of FIG. 1A, may contain a number of discussion rooms 142 with associated delete controls 144.

Beneath the menu bar 152, in some implementations, a number of filtering controls may be presented to filter information presented within a three information item panes 160a, 160b, and 160c arranged beneath the filtering controls. As illustrated, the first information item pane 160a may include a number of thoughts and re-thoughts. The thoughts and re-thoughts, such as a first information post 172a, for example, may be selected for display based upon one or more of recency, interest ranking, acquaintance level of the posting user to the user, and preference of the user for a room in which the thought or re-thought is posted. The order in which the thoughts and re-thoughts are presented in the first information item pane 160a, in some implementations, may similarly be determined using one or more of the recency, interest ranking, acquaintance level of the posting user to the user, and preference of the user for a room in which the thought or re-thought is posted. As illustrated, the first information post 172a may include acquaintance information 130a (e.g., acquaintance name, image, and popularity level) alongside the first information post 172a. In other implementations, a link to a thought or re-thought (e.g., similar to the recommended information items 155 illustrated within the suggested information pane 154) or a preview of a thought or re-thought may instead be presented within the first information item pane 160a.

Next to the first information item pane 160a, the second information item pane 160b, in some implementations, may include a number of replies to information items that the system has determined to be of interest to the user, for example based upon one or more of recency, interest ranking, acquaintance level of the posting user to the user, and preference of the user for a room in which the thought or re-thought is posted. As illustrated, a second information post 172b may include acquaintance information 130c (e.g., acquaintance name, image, and popularity level) alongside the second information post 172b. In some implementations, the information post 172b may be an original information post, and a reply to the information post may have been determined to be of interest to the user. In other implementations, the information post 172b may be a response to an information post, and Acquaintance C 130c may be the responder to the information post. Although illustrated as including acquaintance information 130c alongside the information post 172b, in other implementations, a link to a thought, re-thought, or response thereto (e.g., similar to the recommended information items 155 illustrated within the suggested information pane 154) or a preview of a thought, re-thought, or response thereto may be presented within the second information item pane 160b.

In some implementations, the third information item pane 160c, presented to the left of the second information item pane 160b, may include a number of information posts deemed of interest to the user based upon promotion of the particular information post. For example, as illustrated in the user interface 150, an information post 172c associated with acquaintance information 130b may be presented to the user based upon, in some examples, an acquaintance level between the user and Acquaintance B 130b, a popularity level of Acquaintance B 130b, an acquaintance level between the user and a promoter of the information post 172c (e.g., if different than Acquaintance B 130b), a popularity level of the promoter of the information post 172c (e.g., if different than Acquaintance B 130b), a ranking of the information post 172c in a particular discussion room, and a preference of the user towards the discussion room within which the information post 172c is presented. Although illustrated as including acquaintance information 130b alongside the information post 172c, in other implementations, a link to a thought, re-thought, or response thereto, or a preview of a thought, re-thought, or response thereto may be presented within the third information item pane 160c.

Although the user interface 150 is illustrated in relation to presenting information regarding thoughts, responses, and promotions of thoughts and re-thoughts, in some implementations, an events control 164 may be selected, rather than a thoughts control 162. Upon selection of the events control 164, for example, the first information pane 160a may detail events considered to be potentially of interest to the user. Similarly, the second information pane 160b, in one example, may contain RSVP information considered to be potentially of interest to the user (e.g., Acquaintance C 130c has purchased a ticket to attend a particular event). In another example, the second information pane 160b may contain replies regarding events, where the replies are considered to be potentially of interest to the user (e.g., Acquaintance C 130c has requested parking advice related to a particular event). Furthermore, the third information pane 160c may provide information regarding events that have received promotion from other users who are determined to be of interest to the user.

To locate particular information, such as information regarding a particular topic or discussion room, or information associated with a particular user, in some implementations, a search field 166 may be provided to the user to search the information presented within the information panes 160. In some implementations, for example, a greater number of information posts may be selected for presentation within the information panes 160 than may be presented within a display area at one time. In some implementations, one or more of the information panes 160 may be associated with a scroll bar to allow the user to navigate to additional information. In other implementations, a control such as a “see more” control (not illustrated) may be provided to the user for navigation to further information posts of interest. Through the search field 166, the user may, in some implementations, search all information posts determined to be of interest to the user, whether or not presently displayed within the display panes 160.

In some implementations, to filter the information presented within the information panes 160, the user may select an acquaintance tier control 168. Acquaintances, in some implementations, may be associated with two or more acquaintance tiers, for example based upon closeness of an acquaintance to a user. In a first example, acquaintance tiers may correlate to quintile groupings of all acquaintances of the user (e.g., first quintile 168a, second quintile 168b, third quintile 168c, fourth quintile 168d, and fifth quintile 168e) based upon a total of both promotions of the user on behalf of the acquaintance as well as promotion of the acquaintance on behalf of the user. The acquaintance tiers, in a second example, may correlate to a level of shared interest between the user and an acquaintance. As illustration, in a first acquaintance tier, the acquaintances may represent shared promotions, where the user promotes the acquaintance as well as the acquaintance promoting the user. Further to the example, in a second acquaintance tier, the acquaintances may represent acquaintances that the user frequently promotes, while the acquaintance may promote the user infrequently if ever. At a third level, for example, the acquaintance may frequently promote the user, while the user rarely if ever promotes the acquaintance. Other acquaintance determinations are possible. For example, in some implementations, a fifth acquaintance tier may present the user with one or more other users of the system who are not yet acquaintances of the user, but who demonstrate similar behavior patterns of the user (e.g., have promoted one or more same information items, share one or more favorite discussion rooms, etc.). In some implementations, the system may promote or suggest acquaintances to a user in a different manner.

In addition to filtering by acquaintance level, in some implementations, the user interface 150 may include a timeline bar 170 for filtering the information presented within the information panes 160 by a period of time. In some implementations, the period of time may refer to a period of time beginning in the past up to and including the current time (e.g., in the past 15 minutes, past 30 minutes, past hour, past two hours, past five hours, past twelve hours, past day, past two days, past week, past month, etc.). In other implementations, rather than selecting to view the most recent information, historical posts may be perused by narrowing the displayed posts by a range (e.g., one day ago, last week, last month, etc.

Turning to FIG. 1C, a user interface 180, in some implementations, may represent an example user page (e.g., “My Room”) presented to a user, for example, to provide a user-centric view of a social networking web site. In some implementations, the user interface 180 may be presented to the user in response to selection of the MyInformation control 120. The menu bar 152, suggested information pane 154, recent rooms pane 156, and favorite rooms pane 158 may be similar in content to these regions as described in relation to FIG. 1B. Similarly, the information item panes 160 may contain information items similar in nature to those described in relation to FIG. 1B. However, different filtering mechanisms may be available to the user from within the “My Room” user interface 180.

For example, at the far left beneath the menu bar 152, an activity control 182, when selected, in some implementations may filter the information presented within the information item panes 160 to present information initiated by the user. For example, upon selection of the activity control 182, within the first information item pane 160a, the user may be presented with only those information items which the user thought or re-thought. Similarly, upon selection of the activity control 182, within the second information item pane 160b, the user may be presented with replies initiated by the user. Finally, within the third information item pane 160c, upon selection of the activity control 182, the user may be presented with items the user has previously promoted.

Beneath the activity control 182, in some implementations, a notification control 184 may be presented. The notification control 184, when selected, may display interactions other users have had with information either presented or promoted by the user. For example, upon selection of the notification control 184, within the first information item pane 160a, the user may be presented with re-thoughts of information items which the user originally thought. Similarly, upon selection of the notification control 184, within the second information item pane 160b, the user may be presented with replies to information items (e.g., thoughts, re-thoughts, and responses) initiated by the user. Finally, within the third information item pane 160c, upon selection of the notification control 184, the user may be presented with responses, re-thoughts, or promotions of information items that the user has previously promoted. Although described in relation to thoughts and re-thoughts, in a similar manner, in some implementations, the user may select the activity control 182 or the notification control 184 to filter information regarding events (e.g., by also selecting an events control 164).

To the right of the search field 166, beneath the menu bar 152, in some implementations, a rank filter 186 may be presented. the rank filter 186, upon selection, may provide the user the opportunity to filter the information items presented within the information item pane 160 by a rank (e.g., level of promotion) of each of the information items. In some implementations, the rank filter 186 may be divided by thirds. For example, as illustrated in relation to the user interface 180, a user may select a top third percentile ranking, a middle third percentile ranking, or a bottom third percentile ranking. In reviewing information in relation to percentile rankings, for example, a user may be able to discern the type thoughts, re-thoughts, and responses that others determined to be most (or, conversely, least) interesting.

A “Your Info” control 188, in some implementations, may be included within the user interface 180 to provide the user with a mechanism for accessing demographic or profile information. For example, upon selection of the “Your Info” control 188, the user may be directed to a page (e.g., web page, pop-up window, etc.) containing an interactive presentation for modifying user-specific information. Examples of user-specific information include a user image, a name, and a short description.

As shown in FIG. 1D, user interface 190, in some implementations, may represent an example user page (e.g., “User Room”) presented to a user, for example, to provide a view of a social networking web site in relation to the interactions of a second user (e.g., an acquaintance or other user). In some implementations, the user interface 190 may be presented to the user in response to selection of a user such as Acquaintance A 130a. The user interface 190 is similar to the layout and functionality of the “My Room” user interface 180, described in relation to FIG. 1C. However, in some implementations, an input box 192 may be presented to the user. The user may type information into the input box 192, in some examples, to post a thought to the page of the second user, to respond to a thought or re-thought presented by the second user, or to issue a private message to the second user. In some implementations, prior to posting, the user may be presented with a number of options regarding where to submit the information (e.g., as a post to the second user's User Room, as a private message, etc.). The information submitted via the input box 192, in some implementations, may be associated with a most recent selection made by the user when navigating the user interface 190. For example, should be user select or mouse-over information within the first information pane 160a, the information submitted within the input box 192 may be presented as a reply to a thought or re-thought presented within the first information pane 160a.

In other implementations, a thought may be posted as a private message unless a thought, re-thought, or reply is first actively selected by a user. Upon selection of a thought, re-thought, or reply, in some implementations, the user may be redirected to a discussion room page including the thought, re-thought, or reply.

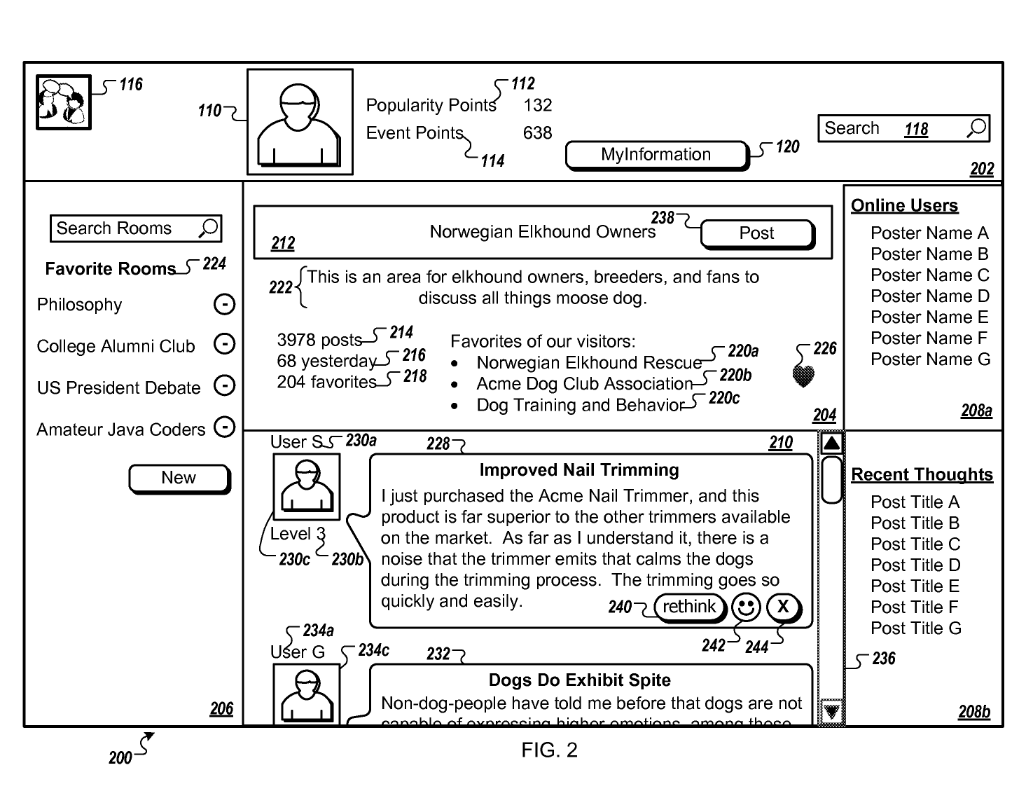

As shown in FIG. 2, a discussion room user interface 200 may include many of the same navigational features as the user interface 100 (e.g., a menu bar 202 containing, for example, similar general navigation information presented to the user as illustrated in the user interface 100 of FIG. 1), a left panel 206 containing, for example, discussion room navigation information, and a right panel 208 containing, for example, information on recent activity of the social networking site. In some implementations, one or more of the menu bar 202, the left panel 206, and the right panel 208 may remain substantially the same as a user navigates through the social networking web site.

In a discussion room center panel 204, in some implementations, the user may be presented with information regarding a particular discussion room such as, in some examples, a title bar 212 (e.g., labeled “Norwegian Elkhound Owners”) and a brief synopsis 222 of the content of the discussion room, as illustrated stating, “This is an area for elkhound owners, breeders, and fans to discuss all things moose dog.”

Beneath this information, in some implementations, the user may be presented with statistical information regarding the discussion room such as, in some examples, a total number of posts 214 (e.g., three thousand, nine hundred seventy-eight), a total number of recent posts 216 (e.g., sixty-eight yesterday) listing the number of posts initiated within a recent time frame (e.g., today, yesterday, last twenty-four hours, etc.), and a total number of favorites 218 (e.g., two hundred and four) providing a tally of the total number of users who have indicated the Norwegian Elkhound Owners discussion room as a favorite discussion room (e.g., as may be illustrated in a favorite discussion rooms section 224 of the left panel 206).

To the left of the statistical information, in some implementations, a listing of similar discussion rooms 220 may display, for example, one or more discussion rooms similar to the Norwegian Elkhound Owners discussion room. The similar discussion rooms 220, in a particular example, may present one or more discussion rooms most frequently selected as a favorite by users who include the Norwegian Elkhound Owners discussion room as a favorite discussion room. In other examples, the similar discussion rooms 220 may include discussion rooms hierarchically related to the Norwegian Elkhound Owners discussion room, most frequently posted to by the top users (e.g., users having the highest popularity level) of the Norwegian Elkhound Owners discussion room, the discussion rooms most frequently re-posted to from posts initiated within the Norwegian Elkhound Owners discussion room, or a combination thereof. As illustrated, the similar discussion rooms 220 may include a “Norwegian Elkhound Rescue” discussion room 220a, an “Acme Dog Club Association” discussion room 220b, and a “Dog Training and Behavior” discussion room 220c. For example, any number of discussion rooms may be listed in the list of similar discussion rooms 220. If the viewing user has not already done so, the user may select a favorites icon 226, here illustrated as a heart, to add the Norwegian Elkhound Owners discussion room to his or her list of favorite discussion rooms 224.

In some implementations, the individual discussion rooms presented within the list of similar discussion rooms 220 may be selected for display, in part, based upon the user currently being supplied with the information. For example, if the user has been previously presented with the “Dog Training and Behavior” discussion room 220c a threshold number of times, upon a subsequent visit to the Norwegian Elkhound Owners discussion room, the user may be presented with a different recommendation. Similarly, based upon historic behavior, recent behavior, demographic information, profile details, or other information associated with the user, various discussion room options may be promoted and/or demoted prior to selection for presentation to the user.

In a post navigational pane 210, in some implementations, the user may be presented with one or more posts initiated within or re-posted to the Norwegian Elkhound Owners discussion room. For example, as illustrated in the post navigational pane 210, a first post 228 entitled “Improved Nail Trimming” may be presented next to user information 230 regarding the user who initiated the post. For example, the user information 230 may include a user identification 230a (e.g., “User 5”) and a user popularity level 230b (e.g., three), as well as a user profile picture 230c. Similarly, a second post 232 entitled “Dogs Do Exhibit Spite” may be presented next to user information 234 including, for example, a user identification 234a (e.g., “User G”) and a user profile picture 234c. A scroll bar 236, for example, may allow the user to view additional posts within the Norwegian Elkhound Owners discussion room. A post control 238, for example, may provide the user, upon selection, with a dialog for initiating a new post within the Norwegian Elkhound Owners discussion room.

When viewing a particular post, in some implementations, only a subset of the information contained in the post may initially be displayed. In some examples, the title, the title and the first “N” characters, or the title and the first sentence may initially be displayed in the post navigational pane 210. Upon selection or mouse-over of the post 228, in some examples, the remainder of the information may be displayed.

In some implementations, the posts presented in the post navigational pane 210 may be listed based upon timestamp, or recency, of each individual post. The ranking of an individual post within the post navigational pane 210 may be influenced by one or more factors including, in some examples, the recency of the post, a number of popularity points associated with the individual post (e.g., an interest level in the post), a popularity level of the user who initiated the post, an acquaintance level shared between the initiator of the post and the viewer of the discussion room user interface 200, and the number and recency of replies to the individual post. In a particular example, the listing of posts may be presented according to a total number of approvals (e.g., popularity points) divided by the length of time since the post was created.

In some implementations, the recency of the most recent reply may factor into the ranking of an individual post. For example, the interest level of a post may “decay” by timeframes such as every 10 minutes, 15 minutes, half hour, hour, three hours, six hours, half day, or day, etc. In this manner, although a particular post may have received an overwhelming number of popularity points, the amount of time since posting may allow the post to eventually lose its position as the top-ranked post within the discussion room.

As illustrated in relation to the first post 228, a rethink control 240, an approval control 242, and a disapproval control 244 may, in some implementations, provide the viewing user with the opportunity to interact with the first post 228. Beginning with the approval control 242 and the disapproval control 244, these controls may be used by a user other than the user who originally posted the information to the first post 228 as a mechanism for evaluating the quality of the information contained in the first post 228. If, for example, a user selects the disapproval control 244, a disapproval level associated with the first post 228 may be adjusted and, based upon relative approval levels and other information regarding the posts presented in the Norwegian Elkhound Owners discussion room, the first post 228 may be decremented in presentation rank (e.g., re-positioned in the user interface 200 beneath the second post 232).

In some implementations, selection of the disapproval control 244 may also reflect upon the originating user associated with the user information 230. For example, the popularity level of User S may be decremented and/or User S may lose popularity points. In one example, selection of the disapproval control 244 may cause popularity points to be debited from the account of the user interacting with the user interface 200. In some implementations, selection of the disapproval control 244 may result in flagging the first post 228 as being abusive or inappropriate. For example, a user may flag the first post 228 as being inappropriate due to obscenity, pornographic material, spam, hateful or discriminatory content, or content not related to the topic of the discussion room. In some implementations, a site administrator may review flagged content to determine whether to take action related to the content. For example, a site administrator may identify an information item as being inappropriate, abusive, or off-topic. An information item identified by the administrator, in some implementations, may be deleted from the social networking web site. In some implementations, rather than deleting the information item, the identified information item may be obscured (e.g., pixilated, overlaid with a semi-opaque censoring image, filtered through a digital image filter to add noise or blurring, etc.) to inhibit further review of the information item, while statistics associated with the information item (e.g., interest level, etc.) or one or more responses posted in relation to the information item may remain visible for users' review. In some implementations, additional information may be identified in relation to an obscured information item such as, in some examples, a number of times flagged by users as inappropriate material, a category of inappropriate material, or a penalty applied to the account of the user who originated the information item.

Selection of the approval control 242, in some implementations, may cause a credit of popularity points to the account of the originating user. The popularity level of the originating user may increase, in some examples, and the interest level of the post may increase in response to receiving an approval through the approval control 242. Due to adjustment of popularity of the user and/or interest level of the post, the position of the post within the Norwegian Elkhound Owners discussion room may be promoted. In one example, even though the post may already be positioned first in rank, receipt of further popularity points may allow the post to hold this position for a longer span of time (e.g., take a longer time to decay based upon the ratio of popularity points to time elapsed).

In some implementations, a user may be limited in the number of times he or she may approve or disapprove of a particular post or of information associated with a particular post (e.g., including replies made to the particular post). In one example, a user may be limited to three approvals and one disapproval for each post (e.g., originating, re-post, or posted response). In another example, a user may be limited to one approval and one disapproval for each post, and to five approvals and five disapprovals for each posting chain (e.g., including both the originating post and all responses branching from the originating post). In one example, a user may select a particular level of approval (e.g., from one to three, etc.) via a drop-down menu or from a number of graphical approval icons.

The rethink control 240, when selected, may in some implementations launch a dialog providing the viewer with a mechanism to post the information in a new location. For example, although posted within the Norwegian Elkhound Owners discussion room, the topic of nail trimming is common to all dog owners. As this information may be of interest to other discussion forums, such as a room devoted to dog owners or to other breed-specific rooms, a user may select the rethink control 240 to re-post the information in one or more locations.

In some implementations, a message may be reposted only once to a particular discussion room. Upon having been re-posted, in one example, a list of re-posting sites (e.g., discussion rooms, sub-rooms, or other forums) may be presented in relation to the first post 228.

Upon re-posting the information, the user may be debited one or more popularity points. For example, similar to applying an approval rating involving a debit of popularity points from the approving user's account, re-posting of information may be associated with a transfer of popularity points from the account of the re-poster to the account of the original poster.

Once information has been re-posted to an additional discussion forum, in some implementations, one or more users may approve, disapprove, or re-post the information from the additional discussion forum. In some implementations, the user who re-posted the information contained in the first post 228 may be credited popularity points for approvals obtained through the discussion forum where the information contained in the first post 228 has been re-posted.

In some implementations, the originating owner may continue to have popularity points credited in relation to approvals, even when the information has been re-posted and is being approved from a different discussion room. If the social networking web site restricts each user to a certain number of approvals per post, for example, approvals to each instantiation of the re-posted information may count towards the maximum. In a particular example, if a user applies the maximum of three approvals to the first post 228 in the Norwegian Elkhound Owners discussion room, the same user may not be allowed to apply another approval to the first post 228 where it is presented in the Shiba Inu Owners forum.

In some implementations, the approval rating of the first post 228 within the Norwegian Elkhound Owners discussion room may have no effect on the ranking of the first post 228 in the discussion forum in which it has been re-posted. For example, should a user re-post the first post 228 to a Shiba Inu Owners forum, the ranking of the first post 228 within that forum may be based upon any approvals or disapprovals received by the first post 228 from within the Shiba Inu Owners forum. Additionally, in the circumstance that the rank of the information contained in the first post 228 is affected by the popularity level of User S, and User S has no established popularity level within the Shiba Inu Owners forum, the ranking of the re-posted information may be adversely affected. In another example, the popularity level of the re-poster within the Shiba Inu Owners forum may, instead or in addition to effecting the originating poster's popularity level, effect the ranking of the information contained in the first post 228.

In some implementations, a user may be presented with a private control (not illustrated) associated with a particular post such as the first post 228. For example, upon selection of the private control, the user may be presented with a dialog box for entering a private message to the originating user (e.g., User S in the example of the first post 228) regarding the first post 228.

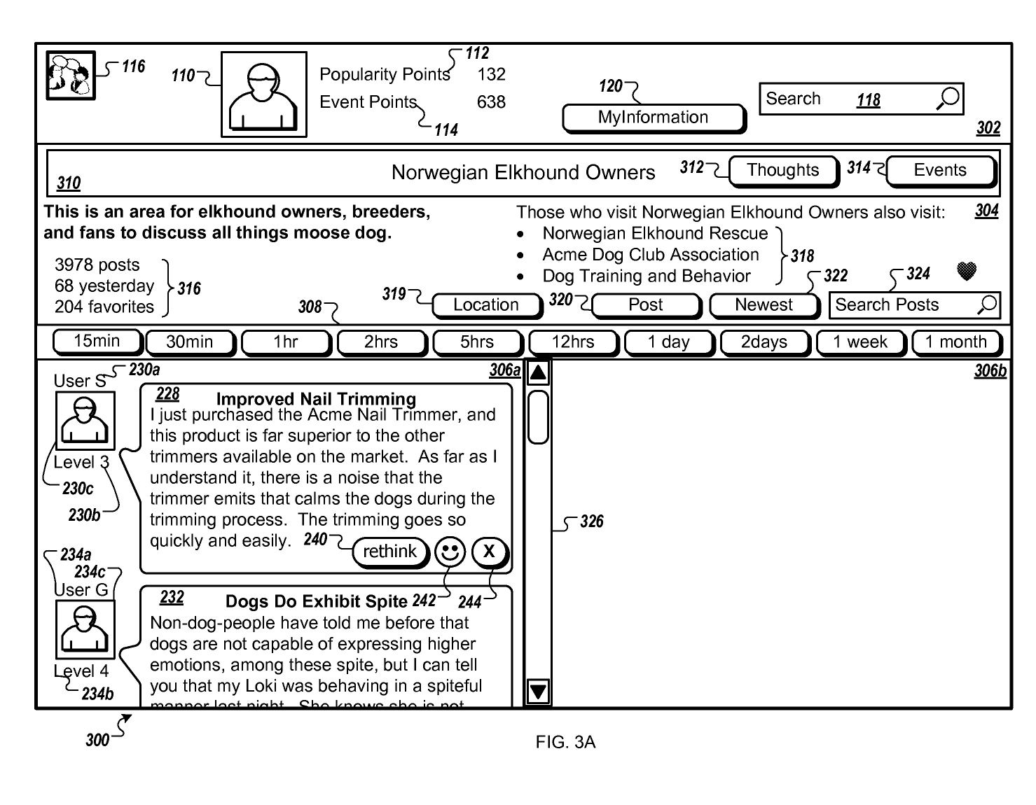

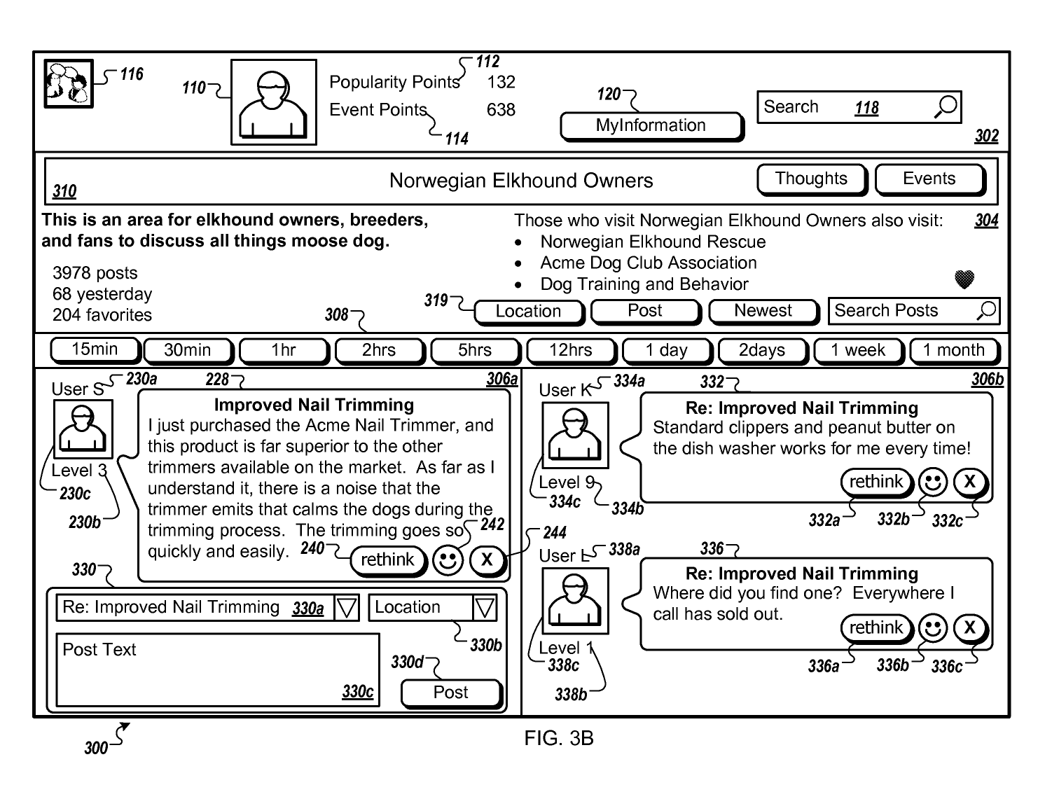

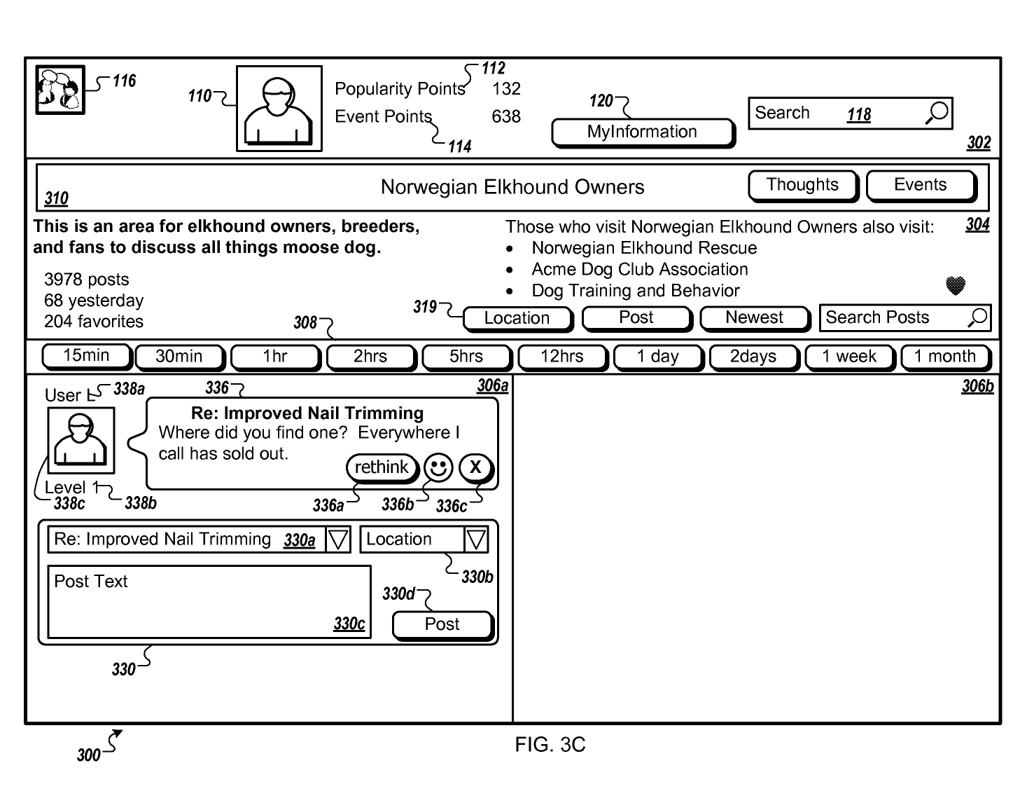

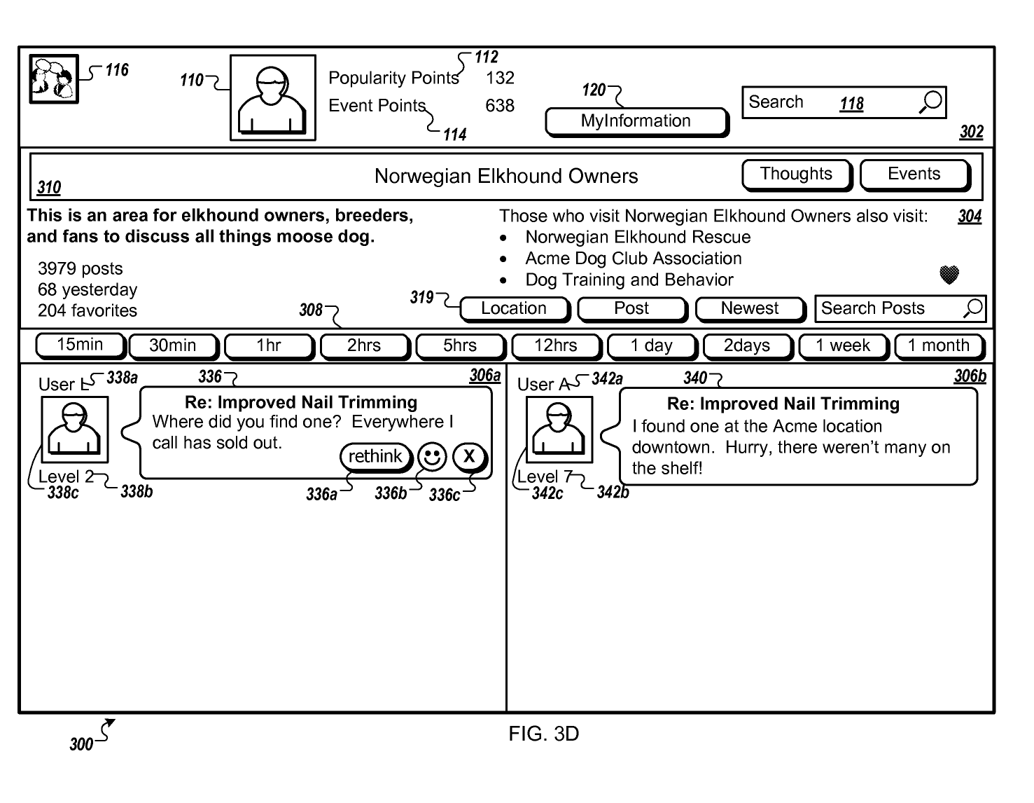

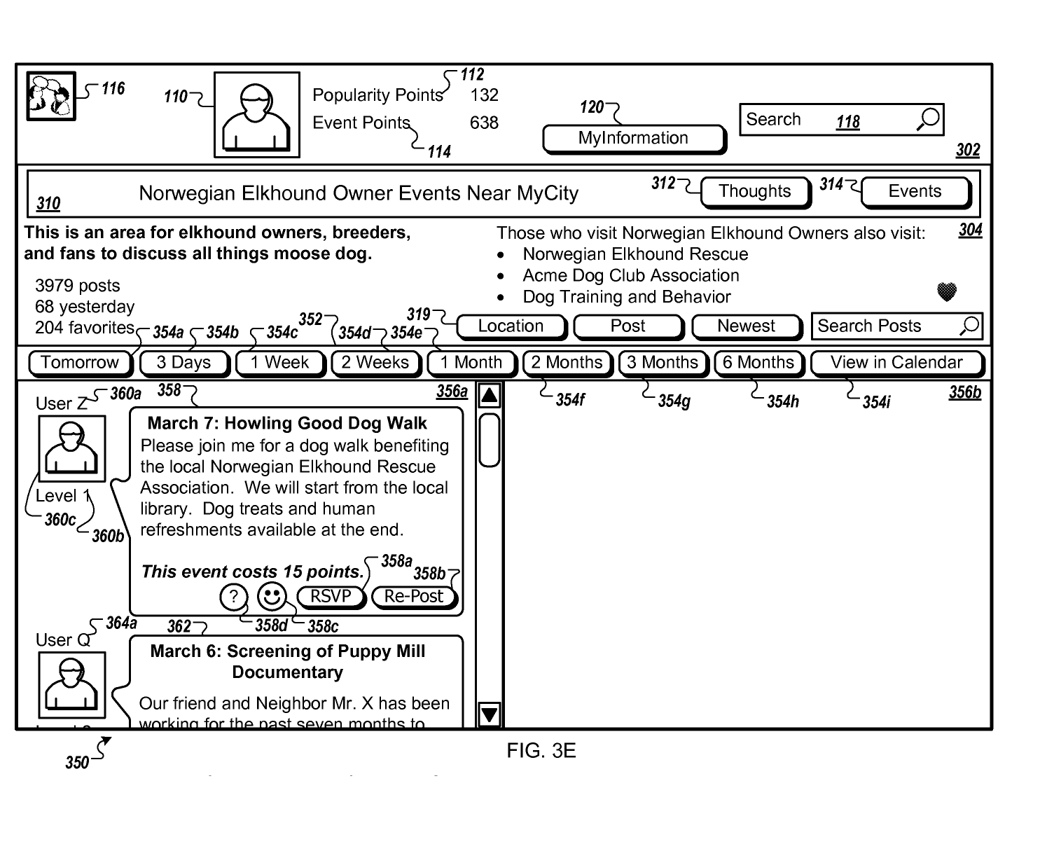

FIGS. 3A through 3E illustrate a number of interactions between a user and the Norwegian Elkhound Owners discussion room through a discussion room user interface 300. The discussion room user interface 300, in some examples, may be used to review, initiate, respond to, re-post, search, and sort individual posts within a discussion room interface. Beginning with FIG. 3A, the discussion room user interface 300 may include a menu bar 302 similar in features to the a menu bar 202 described in relation to FIG. 2. The menu bar 302 may contain, for example, similar general navigation information presented to the user as illustrated in the user interface 100 of FIG. 1. The discussion room user interface 300 may further include a main pane 304 including a title bar 310, for example entitled “Norwegian Elkhound Owners.” The title bar 310, in some implementations may include a thoughts control 312 and an events control 314. The thoughts control 312, for example, may be selectable to display a listing of thoughts (e.g., discussion room posts) within a lower portion of the discussion room user interface 300 (e.g., using a left discussion pane 306a and a right discussion pane 306b). Similarly, the events control 314, for example, may be selectable to display a listing of events within the lower portion of the discussion room interface 300. Beneath the title bar 310, discussion room information similar to the information described in relation to FIG. 2 including, for example, a number of discussion room statistics 316 and a listing of similar discussion rooms 318, may be presented.

A location control 319, a post control 320, a newest control 322, and a search field 324 may be presented beneath the listing of similar discussion rooms 318. The location control 319, for example, may be selected to filter the discussion room to posts related to a particular geographic location. In an example, the geographic location may include the home address of the user or the current location of the user. The geographic location, in some examples, may include a country, province, state, city, or other designation of a particular geographical region (e.g., “New England”, “Twin Cities”, etc.). In some implementations, a drop-down menu (not illustrated) may aid the user in selection of an available geographic location. In some implementations, upon selection of a location, information may be added to the title bar 310 or to the main pane 304, alerting the user that the discussion room scope has been narrowed to a select geographic region.

Rather than a specific geographic location, in some implementations, a user may select an address and a range (e.g., fifty miles). For example, upon selection of Boston, Mass. plus one hundred miles, geographic locations such as Newport, R.I., Worcester, Mass., and Nashua, N.H. may be included in a list of geographic locations for filtering presentation of the discussion room thoughts.

In some implementations, a separate discussion room may already be established that is related to a particular geographic location. For example, the Norwegian Elkhound Owners discussion room may be hierarchically related to one or more regional Norwegian Elkhound Owners discussion rooms. If, for example, a user selected a location of 100 miles from Boston, the user may be presented with the option of visiting the Norwegian Elkhound Owners of the Merrimack Valley discussion room in addition to, or in lieu of, having the posts within the Norwegian Elkhound Owners discussion room filtered by the selected geographic location.

In some implementations, the user may be prompted with the option to create a geographically-specific sub-room of the current discussion room if one does not yet exist. For example, the user may be invited to create a “Greater Boston Area Norwegian Elkhound Owners” discussion room, hierarchically related to the Norwegian Elkhound Owners discussion room.

In some implementations, a geographic range may be provided in relation to events, but not to information posts. For example, through selection of the events control 314, and further selection of the location control 319, a user may review local events related to Norwegian Elkhounds. Events are discussed in further detail in relation to FIG. 3E.

Returning to the controls located in the main pane 304, the post control 320, for example, may be selectable to add a new thought to the discussion room. The newest control 322, in some examples, may be selectable to order the thoughts displayed in the left discussion pane 306a and the right discussion pane 306b by timestamp (e.g., most recent) or to refresh the information displayed in the left discussion pane 306a and the right discussion pane 306b to include thoughts added to the discussion room since the last refresh of the user interface 300. The user may enter information in the search field 324, for example, to locate one or more posts including particular language or posted by a particular user.

A timeframe bar 308 may be positioned beneath the main pane 304. In some implementations, the timeframe bar 308 may include one or more controls to select a timeframe associated with the thoughts presented in the left discussion pane 306a and the right discussion pane 306b. In a first example, rather than displaying all information arranged by a first ranking (e.g., recency, interest level, etc.), the information may be filtered by a range of time (e.g., past 15 minutes, past half hour, past hour, past two hours, past five hours, past twelve hours, past day, past two days, past week, or past month). In another example, rather than selecting to view the most recent information, historical posts may be perused by narrowing the displayed posts by a range (e.g., one day ago, last week, last month, etc.). In this manner, in a particular example, a user may determine the most popular discussions (e.g. using a ranking based in part on popularity points) that took place a month in the past.

Although illustrated in the discussion room user interface 300 as a number of selectable controls, in some implementations a timeframe may be selected using an adjustable slide rule, calendar control, drop down menu(s), or other control allowing the user to select a range of time.

In some implementations, a post may decay to the point where new responses may not be allowed by the social networking web site. For example, if a post has not received a new response in at least a week, the number of posts branching from the originating post may be considered “closed” and the information contained therein held for archiving purposes only. For example, as a post decays, the post may be pruned from the site based in part upon its interest level. For archival purposes, for example, the system may maintain only those posts or strings of posts (e.g., original posts plus one or more responses) based upon the interest level of the topic. In this manner, the system may save storage space while maintaining information which is most likely to be of interest to users in the future.

Turning to the thoughts presented within the Norwegian Elkhound Owners discussion room, the first post 228 entitled “Improved Nail Trimming” and the second post 232 entitled “Dogs Do Exhibit Spite,” as described in relation to FIG. 2, may be presented within the left discussion pane 306a. A scroll bar 326, for example, may allow the user to view additional posts within the Norwegian Elkhound Owners discussion room.

Upon selection of the first post 228, in some implementations, the view illustrated in FIG. 3B of the user interface 300 may be presented to the user. As shown in FIG. 3B, a response dialog box 330, in some examples, may be presented beneath the first post 228 upon selection (e.g., click, double-click, mouse-over, etc.) of the first post 228. The response dialog box 330, for example, may provide the user with a mechanism to respond directly to the information contained in the first post 228. The response dialog box 330, in some examples, may include a title field 330a, a location field 330b, and a response entry field 330c, as well as a post control 330d.

In a particular example, a user may choose to retain the title “Re: Improved Nail Trimming” or to adjust the contents of the title field 330a. The user may also, for example, select a geographic location to associate with the response through the location field 330b (e.g., text entry field, drop-down menu, etc.). The user may, in this example, post a response within the response entry field 330c. Although the response entry field 330c is illustrated as a text entry box, a user may be provided with the opportunity to enter any type of information into the response dialog box 330 such as, in some examples, one or more graphics, audio information, video information, hyperlinks to additional information, or a combination thereof. Once the user has completed adding all information desired into the response dialog box 330, the user, for example, may select the post control 330d to post the reply to the Norwegian Elkhound Owners room.

In some implementations, upon posting a response via the response dialog box 330, the response may be displayed within the right discussion pane 306b. For example, as illustrated in the right discussion pane 306b, the first post 228 may be associated with a first reply 332 posted by a second user 334 and a second reply 336 posted by a third user 338. Each of the users 334, 338, for example, may have different popularity levels 334b, 338b which may, for example, be indicative of the order of presentation of the two replies 332, 336. Each reply 332, 336 may be associated with a respective re-post control 332a, 336a, a respective approval control 332b, 336b, and a respective disapproval control 332c, 336c, each of which may be used, for example, in manners similar to those described in relation to the re-post control 240, approval control 242, and disapproval control 244 associated with the first post 228 and described in relation to FIG. 2.

Selection of the second reply 336, in some implementations, may result in the presentation of information similar to the post layout illustrated in FIG. 3C. As shown in FIG. 3C, for example, the third post 336 may be displayed in the left discussion pane 306a. In some implementations, no posts may be visible within the right discussion pane 306b, for example because no user has posted a response to the second reply 336. The response dialog box 330, in some implementations, may be presented beneath the second reply 336 within the left discussion pane 306a for posting a response to the second reply 336. As illustrated in the user interface 300, the first post 228 may not be present in the display upon drilling down into a response branch. To aid in navigation, in one example, selecting a “back” control (not illustrated) may allow the user to navigate back to the first post 228. In another example, a hierarchical structure (not illustrated), such as a selectable listing of titles or title portions within the hierarchy, may be visible to the user within the user interface 300 for ease of navigation.

Because the second reply 336 deals with the purchase of a product, a response may include information regarding a particular brick and mortar store. In one example, the user, upon posting a reply, may indicate a geographic location via the location control 330b to associate the response with a geographic location encompassing the location of the brick and mortar store. If a particular geographic location has been selected in relation to creation of the response, for example, upon filtering for a geographic location encompassing the geographic location selected (e.g., via the location control 319), a user may be presented with the posted response.

Upon posting a response to the second reply 336, in some implementations, the response may be displayed in the right discussion pane 306b, for example as illustrated in FIG. 3D. Turning to FIG. 3D, the second reply 336 may be presented in the left discussion pane 306a while a user-entered reply 340 may be presented in the right discussion pane 306b. The user-entered reply 340, for example, may be associated with a user 342 including a user identifier 342a of “User A”, a user image 342c, and a popularity level 342b of seven.

In some implementations, upon posting a reply to the user-entered reply 340, the user-entered reply 340 may shift to the left discussion pane 306a, while the new reply may be presented in the right discussion pane 306b. For example, the second reply 336 may be replaced by the user-entered reply 340. To navigate back to the second reply 336, in some implementations, a “back” or “up a level” navigation tool (not illustrated) may be presented to the user. In other implementations, a user may select a back control of a browser in which the user interface 300 is rendered to return to the previous view (e.g., moving from the view presented in FIG. 3D to the view presented in FIG. 3C).

In other implementations, a third discussion pane, to the right of the right discussion pane, may contain the new reply. In some implementations, any number of columns may be illustrated for the user to navigate a number of replies and responses to replies. The number of columns, for example, may depend upon the level of embedding of the structure of responses. If the level of embedding of the responses requires more columns than can be adequately displayed within a user display, in some implementations, a horizontal scroll bar (not illustrated) may be provided to the user to navigate the response columns. In some implementations, other navigational elements, such as back and forward arrow controls, may be provided to the user to navigate the response columns.

In some implementations, by posting the new reply 340, an acquaintance may be established between User A and User L (as named in a user identifier 338a associated with the second reply 336).

In some implementations, a popularity level 338b associated with User L may be adjusted based upon the addition of the new reply 340. For example, as is evidenced in a comparison of FIG. 3C and FIG. 3D, the popularity level 338b of User L has increased from popularity level 1 to popularity level 2. In some implementations, the popularity level 338b may be based, in part, on a total number of acquaintances of User L, a total number of popularity points provided in approval of information provided by User L, and/or an acquaintance level between User L and one or more users (e.g., of the discussion room or of the social networking web site).

In some implementations, one or more popularity points may have been debited from a popularity points account associated with User A (e.g., the user who posted the new reply 340).

As illustrated, the new reply 340 may not include controls for re-posting, approving, or disapproving, for example because the user interface 300 presents information to the originator of the new reply 340. In some implementations, the originator of the new reply 340 may be presented with the option to re-think the information in a different discussion room. For example, User A may be presented to opportunity to spend one or more popularity points to re-think the new reply 340 in additional discussion rooms. In a particular example, if the second reply 336 were re-posted in another discussion room, User A may feel that the new reply 340 would be beneficial to the readers of the second discussion room.

In some implementations, User A may be provided an opportunity to self-promote the new reply 340 by spending popularity points to increase the approval rating of the new reply 340. In some examples, the social networking site may debit a greater value from a user account for self-promotion as compared to the quantity of points debited to promote a different user's account via providing an approval (e.g., using an approval control such as the approval control 336b).

Turning to FIG. 3E, an events user interface 350 may provide information regarding one or more events associated with a particular discussion room (e.g., the Norwegian Elkhound Owners discussion room). For example, as illustrated in FIG. 3E, the title bar 310 may include an updated title of “Norwegian Elkhound Owner Events Near MyCity.” In some implementations, the user may be presented with the events user interface 350 upon selection of the events control 314 in the title bar 310. Events, for example, may include activities scheduled at a particular time and particular geographic location. In some implementations, the social networking web site may promote attendance at events by providing users with the opportunity to earn popularity points for initiating popular events. The interest level of an event, for example, may be linked to the number of users who are registered to attend the event. In some implementations, a popularity points “cost” of an event may factor into the interest level of an event along with the number of registered attendees.

A number of events may be presented in a left events pane 356a. For example, as shown in FIG. 3E, a first event 358 regarding a dog walk has been posted by User Z 360, while a second event 362 regarding a puppy mill documentary screening has been posted by User Q 364. In some implementations, respective user popularity levels 360b and 364b (not illustrated) of User Z 360 and User Q 364, may indicate a popularity level associated with the overall discussion room (e.g., based in part upon interaction in posting and approving information or in number of acquaintances and/or acquaintance levels between User Z and User Q, respectively, and other users who have interacted with the discussion room). The user popularity levels 360b and 364b, in some implementations, may be indicative or effected by participation in events through the events user interface 350.

The first event 358, in some implementations, may be associated with a registration control 358a (labeled RSVP), a re-post control 358b (labeled “re-post”), an interest control 358c (e.g., illustrated by a happy face), and a reply control 358d (e.g., illustrated by a question mark). Upon selection of the registration control 358a, for example, a user may be presented with a dialog for registering for the first event 358. Further to the example, registration may include paying a number of popularity points to secure a virtual ticket to the event. For example, according to the first post 358, the dog walk event is associated with a price of fifteen points.

When a user registers for an event, the originating user, in some implementations, may be credited a number of popularity points. For example, based upon the cost of an event, an originating poster may receive an associated number of popularity points in recognition for the RSVP.

In some implementations, the fifteen points cost of the first event 358 refers to a number of event points. For example, event points associated with a user of the social networking web site may be held in a separate account from the user's popularity points. For example, based upon interactions by the user (e.g., posting, responding, approving, etc.) within the discussion room, the user may accrue both a first number of popularity points and a second number of event points, where event points may be used exclusively for registration to attend events.

The cost associated with an event, in some implementations, may provide a user with registration for two people (e.g., to bring a friend not affiliated with the social networking web site). In one example, an event may be associated with multiple costs depending upon the size of the party in the response (e.g., forty points for user registration, sixty points for user plus friend).

A user may re-post (e.g., “re-throw”) an event to a separate discussion room, in some implementations, in a manner similar to re-posting a thought of a user. For example, although the first event 358 may be posted to the Norwegian Elkhound Owners events list, any dog owner may be interested in a local dog walk benefiting the Norwegian Elkhound Rescue Association. Thus, a user may select the re-post control 358b to re-post the first event 358 to a different discussion room, such as a generic dog rescue discussion room. The user selecting the re-post control 358b, in one example, may be debited a number of popularity points and/or a number of event points for re-posting an event. Determination of the interest level of the re-posted event in the new discussion room, for example, may function similarly to the re-post operation for user thoughts as discussed in relation to FIG. 2.

In some implementations, a user may demonstrate appreciation for the event by selecting the interest control 358c. For example, approval of an event may have a similar effect as an approval towards an information post. For example, an acquaintance level between an organizer of the event and the user submitting the approval may be initiated or, if already existing, adjusted. A popularity level of one or both of the organizer and the submitter of the approval may be adjusted, for example based upon a number of popularity points associated with the approval or according to an adjustment of acquaintance levels. In some implementations, approvals applied to an event may affect the ranking of the event within the events user interface 350. For example, based in part upon a relative number of approvals applied to each of the events within the events user interface 350, the ranking of the various events may be adjusted. In some implementations, the user need not necessarily be registered to attend the first event 358 to approve of the first event 358.

In some implementations, a user may post a comment regarding an event or ask a question related to the event by selecting the reply control 358d. A user may post a comment, for example, requesting additional information such as “may my pet pygmy goat attend the dog walk?”

As illustrated in the events user interface 350, the events displayed may be associated with a particular geographic location (e.g., “MyCity”). In some implementations, upon selection of the events control 314, the display may default to a geographic location associated with the user account (e.g., a home address). Selection of the location control 319, for example, may provide the user the opportunity to change the geographic location of the presentation within the events user interface 350.

The events user interface 350 may include a calendar timeline 352, for example including controls labeled “tomorrow” 354a, “three days” 354b, “one week” 354c, “two weeks” 354d, “one month” 354e, “two months” 354f, “three months” 354g, “six months” 354h, and “view in calendar” 354i. In some implementations, selection of one of the controls 354a through 354i may cause the application of a timestamp filter, such that only events landing within the labeled timeframe or more recent may be presented to the user within the left events pane 356a.

Upon selection of a particular event, such as the first event 358 or the second event 362, in some implementations, detailed information regarding the event may be presented within the left events pane 356b. For example, upon selection of the first event 358, a listing of users already registered for the first event 358, a time and address of the event, a map interface for locating the event, and/or user comments (e.g., similar to replies to posts) regarding the first event 358 may be displayed.

In a particular example, upon selection of the first event 358, detailed information regarding the first event such as, in some examples, the time, address, and a map interface, may be presented in the left events pane 356a, while a list of registered users and user comments may be presented in the right events pane 356b.

In some implementations, users may be provided the opportunity to approve or disapprove of a particular user comment regarding an event. For example, should a user request attendance instructions in the event that it rains (e.g., canceled, rain date, etc.), other users may also be interested in viewing the response. Thus, users may submit an “approval” to the particular comment regarding the event, promoting the comment such that others interested in the event may be more likely to view the particular question regarding rain.

In some implementations, a user may be required to achieve a certain popularity level prior to having the opportunity to host an event. In one example, upon receipt of a threshold number of approvals related to posts made in the Norwegian Elkhound Owners discussion room, a particular user may be authorized to host events (e.g., create new event listings) associated with Norwegian Elkhounds.

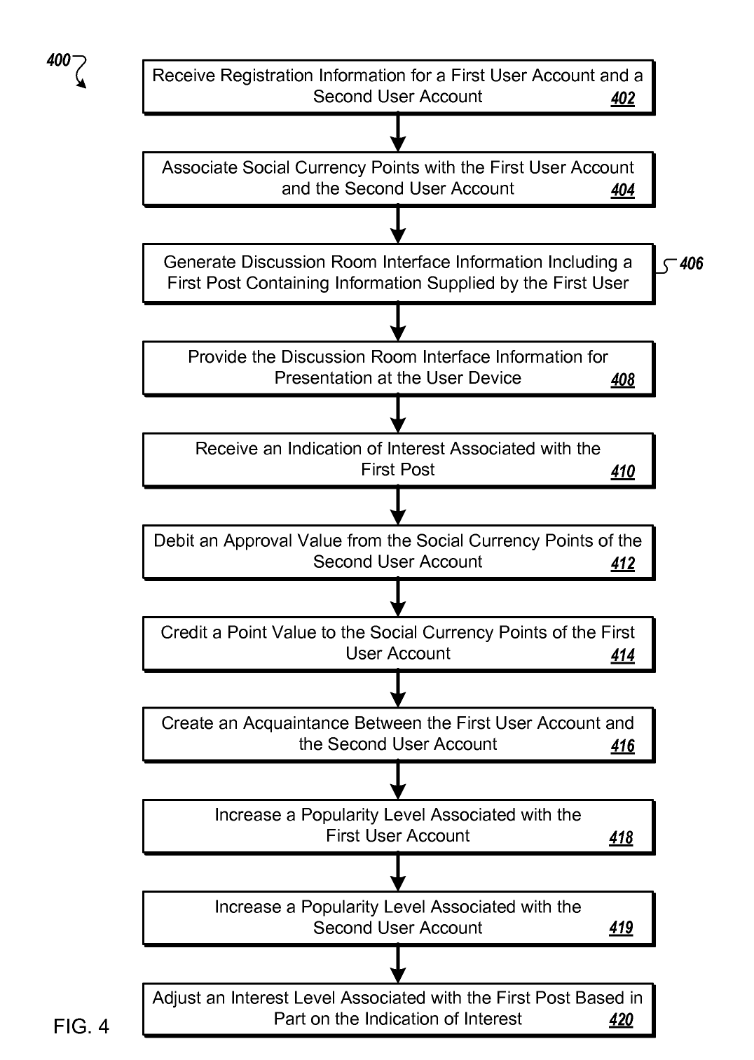

Referring now to FIG. 4, a flow chart for an example method 400 for transferring social currency points within a social networking web site is illustrated. The method 400 may begin with receiving (402) registration information for a first user account and a second user account at a social networking web site. Registration information, in some examples, may include user demographic information, user interest information, an email address, a password, and an agreement to comply with the rules and regulations of the social networking web site.

Social currency points may be associated (404) with the first user account and the second user account. In some examples, upon registering for an account, a quantity of social currency points may be associated with the new account. In some implementations, a user may be credited social currency points in relation to performing initial activities through the social networking web site. For example, upon posting information to the social networking web site, the user may be allocated a first quantity of social currency points. Further to the example, after having posted information a threshold number of times (e.g., five, ten, twenty, etc. information posts), a user may be allocated a second quantity of social currency points. With the new social currency points, for example, a user may begin to interact with the social networking web site. In some implementations, rather than automatically receiving social currency points with a new account, a user may first perform certain new user tasks, such as selecting at least one discussion room as a favorite or filling in personal information in a user profile, before being allocated social currency points.

Discussion room interface information may be generated (406) for the second user. For example, the discussion room interface information may include one or more of hypertext transport protocol code, applet code, text information, graphic information, video information, and audio information to be used in displaying a discussion room interface at a user device. The discussion room interface information may be associated with a topic or topic category. The discussion room interface information may include a first post containing information supplied by the first user or another method for accessing information supplied by the first user in a first post. Additionally, in one example, the discussion room interface information may include information to generate a discussion room user interface including a number of information posts, responses to posts, and controls provided to the second user to interact with in relation to the information presented in the discussion room.

The discussion room interface information may be provided (408) for presentation at a user device. For example, the discussion room interface information may be delivered via a computer network from one or more servers providing content for the social networking web site to the user device. In some implementations, the discussion room interface information may be combined and/or modified for combination with additional information prior to being delivered to the user device for presentation to the second user. In some implementations, the user may access a portion of the discussion room interface information by connected to a cloud-based computing application for delivering services of the social networking web site.

An indication of interest associated with the first post may be received (410). In some implementations, the second user may activate an approval mechanism, indicating interest in the contents of the first post. The social networking web site, in a particular example, may receive an indication of interest including a user identifier associated with the second user and a post identifier associated with the first post. The indication of interest, in some implementations, may be provided through selection of a graphical control in a user interface presenting information provided in the first post.

An approval value may be debited (412) from the social currency points of the second user account. In some implementations, responsive to the indication of interest provided by the second user, one or more social currency points may be debited from the user account of the second user. The second user, in some implementations, may indicate a particular level of interest with the first post (e.g., mild, moderate, strong, etc.), correlating to a particular number of social currency points (e.g., one, two, three, etc.) to be debited from the social currency points of the second user.

In some implementations, the quantity of social currency points debited may depend, in part, upon the popularity level of the second user. For example, if the second user is one of the most popular users within the particular discussion room, the approval of the second user may hold a greater value, translating to a greater number of social currency points being debited from the account of the second user.

A point value may be credited (414) to the social currency points of the first user account. For example, the number of social currency points credited to the first user account may be equivalent to the number of social currency points debited from the second user account. The social currency points, in another example, may be distributed between a first social currency points account and a second events points account.

In some implementations, the quantity of social currency points credited may depend, in part, upon the popularity level of the second user. For example, if the second user is one of the most popular users within the particular discussion room, the approval of the second user may hold a greater value, translating to a greater number of social currency points being credited to the account of the first user.

An acquaintance may be created (416) between the first user account and the second user account based upon the approval indication provided by the second user. In some implementations, the acquaintance level between users may be considered when positioning a post generated by one of the users within a discussion room interface generated on behalf of the other user. In some implementations, the acquaintance level may not be reflective in the pair, in other words, user A may have a higher acquaintance level with user B than user B has with user A. Further to this example, user A may frequently approve of information posted by user B while user B has indicated little or no interest in information posted by user A, resulting in user A having a higher acquaintance level with user B than user B has with user A.

A popularity level associated with the first user account may be increased (418). The popularity level of a user, in some implementations, may be based in part upon the creation of the acquaintance between the first user account and the second user account. For example, the popularity level may be based in part upon a number of acquaintances between the user and other users of the social networking web site. In some implementations, the popularity level of a user may be based in part upon an acquaintance level between the user and one or more users of the social networking web site.

In some implementations, the popularity level may be based in part upon the approval value. In some implementations, the popularity level of the first user may be based upon or equivalent to the total number of social currency points the first user has “earned” via the social networking web site. The first user may earn points, for example, through approvals to user posts or through registrations to user events. In some implementations, the popularity level of a user may be demoted based upon one or more disapprovals received via the social networking web site.

In some implementations, the popularity level may be determined using a proprietary method based in part upon information regarding the user (e.g., from the user profile). The popularity level of a user, in some implementations, may be considered when positioning a post generated by that user within a discussion room interface.

In some implementations, a popularity level associated with the second user account may be increased (419). The popularity level of the second user, in some implementations, may be based in part upon the creation of the acquaintance between the first user account and the second user account. For example, the popularity level may be based in part upon a number of acquaintances between the user and other users of the social networking web site. In some implementations, the popularity level of a user may be based in part upon an acquaintance level between the user and one or more users of the social networking web site. In some implementations, the popularity level of the second user may be adjusted in a same manner as the popularity level was adjusted in relation to the first user (e.g., at 418). For example, a particular popularity level percentage increase or numerical increase may be applied in relation to both the first user and the second user. The popularity level of the second user, in some implementations, may be modified in a different manner than the popularity level of the first user. For example, popularity level may rise more dramatically in relation to receiving the approval of others than in providing approval to others.

An interest level associated with the first post may be adjusted (420) based in part on the indication of interest. In some implementations, an order of presentation of information posts within a discussion room may be based in part upon the number of approvals received in relation to each of the information posts added to the discussion room. In a particular example, the interest level associated with a particular post may include all approvals submitted in relation to the post minus all disapprovals submitted in relation to the post. Further to this example, when later generating discussion room interface information including the first post, the position of the post within the discussion room interface may be based in part upon, e.g., a ratio between the interest level of the post and the relative timestamp of the post in comparison to the interest level to timestamp ratio of other posts in the discussion room.

Although described in a particular order, the steps of the method 400 may in some implementations be performed in a different order, and in some examples more or fewer steps may be involved in the method 400. For example, in some implementations creating (418) an acquaintance may be replaced by adjusting an acquaintance level, should an acquaintance between the first user and the second user already exist. Although described in relation to a “post”, in this context a post may include both a user information post and a user event.

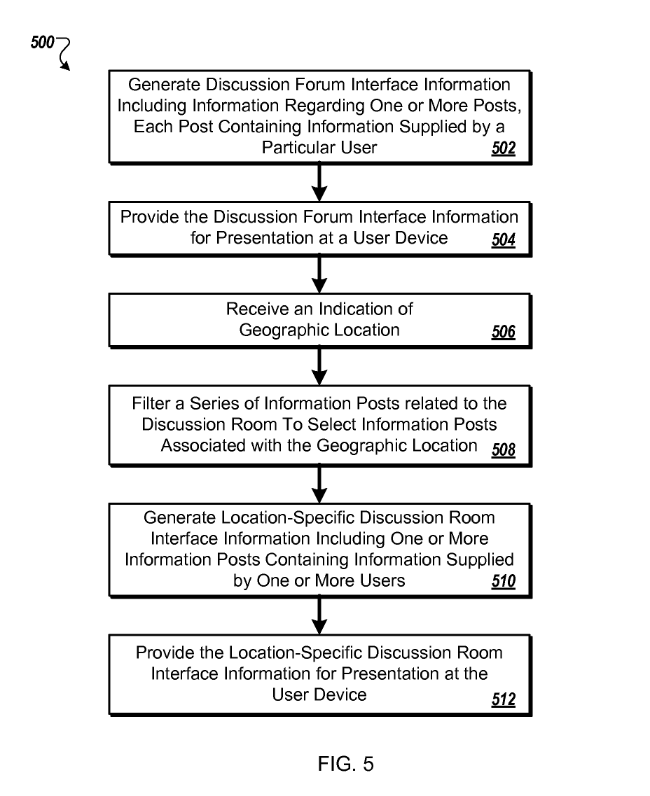

Referring now to FIG. 5, a flow chart 5 illustrates an example method 500 for filtering a discussion forum interface within a social networking web site based upon indication of a geographic location. The method 500 may begin with generating (502) discussion forum interface information including information pertaining to one or more information posts, each information post containing information supplied by a particular user of the social networking web site. For example, the discussion forum interface information may include one or more of hypertext transport protocol code, applet code, text information, graphic information, video information, and audio information to be used in displaying a discussion forum interface at a user device. In some implementations, the discussion forum interface information may be associated with a topic or topic category. The discussion forum interface information, in some implementations, may include a number of graphically-displayed “thoughts” each containing information supplied by a particular user of the social networking web site. In some implementations, the discussion forum interface information may include a number of graphically-displayed “events” each containing information supplied by a particular user of the social networking web site

In some implementations, the discussion forum interface information may contain a mechanism for accessing each of the number of information posts supplied by users of the social networking web site. For example, the discussion forum interface information may include information to generate a discussion forum user interface including one or more of a number of information-based user thoughts, a number of event listings, responses to one or more of the number of information-based user thoughts, responses to one or more of the number of event listings, and controls provided to a user to interact with relation to the information presented in the discussion forum.

The discussion forum interface information may be provided (504) for presentation at a user device. For example, the discussion forum interface information may be delivered via a computer network from one or more servers providing content for the social networking web site to the user device. In some implementations, the discussion forum interface information may be combined and/or modified for combination with additional information prior to being delivered to the user device for presentation to the user. In some implementations, the user may access a portion of the discussion room interface information by connecting to a cloud-based computing application for delivering one or more services of the social networking web site.

An indication of geographic location may be received (506). In some implementations, a user may activate a control within a user interface to select a particular geographic location. The geographic location, in some examples, may indicate one or more of a country, province, region, state, city, or radius in distance from a specified address. In an example, the geographic location may be determined by a global positioning service application or other location-determining application available via the user device.

A number of information posts related to the discussion forum may be filtered (508) to select one or more information posts associated with the geographic location. In some implementations, a user, when creating a new thought, may actively specify a location associated with the thought. For example, using a map interface, drop-down menu, or text entry field, a user may specify a particular geographic location associated with a user thought. In some implementations, an event may be associated with an event address or an event meeting point (e.g., if the event includes a charitable walk, bus trip, or other travel).

Location-specific discussion forum interface information may be generated (510). The location-specific discussion forum interface, in some implementations, may include one or more information-based user thoughts containing information supplied by one or more users, where each of those one or more users specified a geographic location encompassed by the geographic location indicated. For example, the location-specific discussion forum interface information may be generated in a similar manner as described above in relation to step (502).

The location-specific discussion forum interface information may be provided (512) for presentation at the user device. For example, the location-specific discussion forum interface information may be provided for presentation at the user device in a similar manner as described above in relation to step (504).

Although described in a particular order, the steps of the method 500 may, in some implementations, be performed in a different order, and in some examples the method 500 may include more or fewer steps. For example, in some implementations, rather than generating (502) and providing (504) discussion forum interface information, the method 500 may begin with receiving (506) an indication of geographic location (e.g., either actively by the user or passively through user account-derived information or user device-derived information). For example, the presentation of events may default to a home region (e.g., a home address specified by the user or a home city/state, etc.). In another example, the presentation of events may default to a region surrounding a geolocation derived from global positioning information obtained through a sensor of a user device.

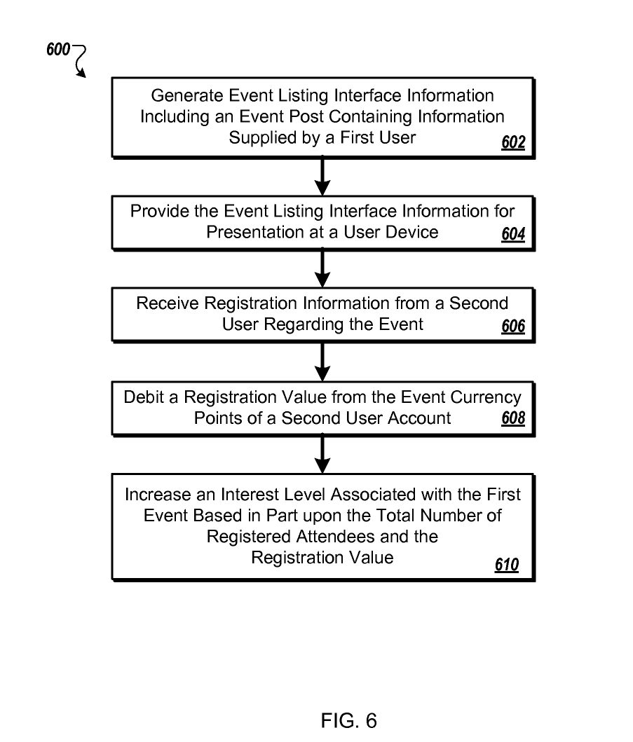

Referring now to FIG. 6, a flow chart illustrates an example method 600 for registering for an event via a social networking web site. The method 600 may begin with generating (602) event listing interface information including an event post containing information supplied by a first user. For example, the event listing interface information may include one or more of hypertext transport protocol code, applet code, text information, graphic information, video information, and audio information to be used in displaying an event browsing interface at a user device. In some implementations, the event listing interface information may be associated with a topic or topic category. The events within the event listing interface information, in some implementations, may all be associated with a particular geographic location or region. The event listing interface information, in some implementations, may include a number of graphically-displayed events each containing information supplied by a particular user of the social networking web site. In some implementations, the event listing interface information may contain a mechanism for accessing each of the number of events supplied by users of the social networking web site. In an example, the event listing interface information may include information to generate an event listing user interface including the number of user-initiated events, registration information pertaining to one or more of the number of user-initiated events, user comments regarding one or more of the number of user-initiated events, and controls provided to a user to interact with in relation to the information presented in the events listing interface (e.g., used to register for an event, request more information regarding an event, or re-post the event in another events interface associated, for example, with another topic or topic category).

The event listing interface information may be provided (604) for presentation at a user device. For example, the event listing interface information may be delivered via a computer network from one or more servers providing content for the social networking web site to a user device. In some implementations, the event listing interface information may be combined and/or modified for combination with additional information prior to being delivered to the user device for presentation to a second user. In some implementations, the user may access a portion of the event listing interface information by connecting to a cloud-based computing application for delivering one or more services of the social networking web site.

Registration information may be received (606) from the second user regarding the event. In some implementations, a user may activate a control within the event listing user interface to RSVP to a particular event. The registration information, in some examples, may include one or more of a user identifier identifying the second user, an event identifier identifying the event, a head count indicating the number of attendees being registered for the event, and user contact information (e.g., email, phone number, mailing address, etc.) used to transmit an electronic ticket or a physical ticket to the attendee. In some implementations, the user contact information or other user identifying information may be derived from the user account (e.g., accessed using the user identifier).

A registration value may be debited (608) from the event currency points of a second user account associated with the second user. For example, responsive to the registration information provided by the second user, one or more event currency points may be debited from the user account of the second user. The second user, in an example, may indicate a particular number of attendees, correlating to a particular number of event currency points (e.g., ten, fifteen, etc.) to be debited from the event currency points of the second user.

In some implementations, the event currency points may be equivalent to social currency points, and the amount may be debited from a single account. The event currency account, in some implementations, may contain points held separately from social currency points used for interacting with user posts in discussion rooms. In some implementations, event registration may be paid for with either event currency points or social currency points. For example, if the event currency account of the user contains twelve event currency points, and registration cost for an event is fifteen event currency points, an equivalent amount of social currency points may be debited from a social currency account of the second user to complete the registration. In some implementations, the value of social currency points may differ from the value of event currency points. In a particular example, one event currency point may be equivalent to five social currency points.

An interest level associated with the first event may be increased (610) based in part upon the total number of registered attendees. In some implementations, calculating the interest level of the first event may include computing a ratio of the total number of registered attendees to the registration value. The interest level of an event, in some implementations, may be considered when positioning an event within a discussion room interface. For example, events with a higher interest level may be positioned above events with a lower interest level, where the events are scheduled to occur within a similar timeframe.

Although described in a particular order, the steps of the method 600 may in some implementations be performed in a different order, and in some examples the method 600 may include more or fewer steps. For example, in some implementations, the method 600 may further include crediting a social currency value to a first user account associated with the first user who initiated the event listing.

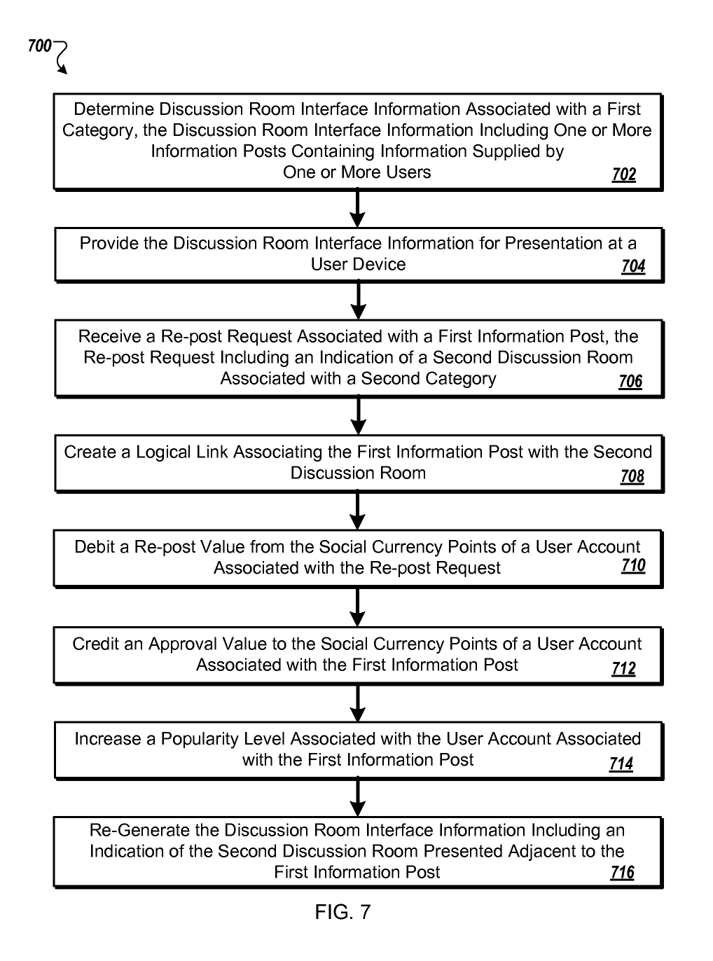

Referring now to FIG. 7, a flow chart illustrates an example method 700 for re-posting information between discussion rooms of a social networking web site. The method 700 may begin with determining (702) discussion room interface information associated with a first category. The discussion room interface information, for example, may include one or more information posts containing information supplied by one or more users. For example, discussion room interface information generation may be achieved in a manner similar to that described in relation to step 406 of the flow chart 400 illustrated in FIG. 4.

The discussion room interface information may be provided (704) for presentation at a user device. For example, discussion room interface presentation may be achieved in a manner similar to that described in relation to step 408 of the flow chart 400 illustrated in FIG. 4. The presentation of the discussion room interface, for example, may include a re-think control selectable for re-posting information associated with the re-think control.

A re-post request associated with a first information post may be received (706). In some implementations, the re-post request may include an indication of a second discussion room associated with a second category. The re-post request, for example, may be initiated by a user by selecting the re-think control described above.

In some implementations, the social networking web site system may verify that the first information post is eligible for re-posting in the second discussion room. For example, the system may verify that the first information post has not already been re-posted to the second discussion room.

In some implementations, the system may verify that the user who posted the re-post request is eligible for re-posting the information. In some implementations the originating user may be the only user allowed to re-post the information, for example based upon user preferences, discussion room preferences, or a system-wide rule. In another example, the system may verify that the user who issued the re-post request has available resources to initiate the re-posting of the information. Further to this example, in some implementations, the user re-posting the information may be debited a certain amount of social currency points for re-posting the information. If the user does not have the necessary number of social currency points within his or her social currency point account, for example, the re-post request may be denied.

In some implementations, a user may have the option of making information private to a single discussion room interface. For example, a private group of users (e.g., members-only social club, corporate employees, private organization, etc.) may hold discussions in a discussion room accessible only to those who have membership to the discussion room. Information posted to such a discussion room, for example, may be private to that discussion room, such that re-posting information outside the private discussion room may be disallowed by the system. In some implementations, whether or not a discussion room is private, a user may have the option to apply a “this discussion room only” lock on a post created for a discussion room, blocking re-posting of the information.

In some implementations, a post may be automatically associated with a second discussion room when created for posting in a first discussion room. For example, if the post was initiated within a sub-room of the second discussion room, the second discussion room may already hierarchically inherit a “re-posting” of the information contained in the first information post. In this circumstance, for example, the system may block the re-posting of the information into the second discussion room because the information already exists (logically) within the second discussion room.

A logical link associating the first information post with the second discussion room may be created (708). The system, in some implementations, may maintain a single copy of the information posted by the user. Upon re-posting of the information, a logical link may be generated between the post and the additional discussion room. Associated with presentation of the first information post, for example, may be a list of all of the other discussion rooms presenting the same post. For example, this may be considered an action of associating the post with the second discussion room.

In some implementations, a post may be associated with any number of discussion rooms. In some implementations, there may be a cap on the number of times an information post may be re-posted within the system. For example, a particular post may only be allowed to be posted within a certain percentage of the total number of discussion rooms within the system (e.g., ten, twenty-five, etc.). In another example, a cap of a total number of discussion rooms may be applied (e.g., five, eight, etc.). A re-posting cap, for example, may discourage spamming between discussion rooms.

A re-post value may be debited (710) from the social currency points of a user account associated with the re-post request. For example, the user initiating the re-post request may be charged a particular quantity of social currency points to re-post the information to the second discussion room. In one example, the amount charged for re-posting may be a “flat fee”, e.g., a standard amount debited from the account of a user upon re-posting of any type of information. The amount charged to the user, in another example, may depend on a number of factors including, in some examples, one or more of an interest level of the first information post, a number of times the first information post has already been re-posted, a number of times that this particular user has already re-posted the first information post, the number of users who indicated the first discussion room as a favorite, and the number of users who have indicated the second discussion room as a favorite. In a particular example, the user may be charged a first amount to re-post the first information post to discussion room A and, upon requesting an additional re-post of the first information post, this time to discussion room B, the user may be charged a second amount greater than the first amount.

An approval value may be credited (712) to the social currency points of a user account associated with the first information post. The user account associated with the first information post, for example, may belong to the user who initiated the first information post. In another example, the user account may include the user who initiated an original post, the first information post being a response to the original post. The approval value, in one example, may be equivalent to the re-post value charged for the re-posting operation.

In some implementations, upon a re-post operation, two or more users may be credited an approval value. In one example, the user who initiated a response may be credited a first approval value, and the user who initiated the original post may be credited a second approval value. In another example, a post may be re-posted from a location in which it was previously reposted. Further to this example, consider a first post originated by User A in Discussion Room X, and re-posted by User B in Discussion Room Y. Should User C choose to re-post the first post from Discussion Room Y to Discussion Room Z, the user who initiated the first information post (e.g., User A) may be credited a first approval value, and the user who re-posted the information to the Discussion Room Y (e.g., User B) may be credited a second approval value. If two or more users are credited an approval value associated with the re-posting of the first information post, in some implementations, the particular approval value credited to each user may vary depending upon the relationship between each user and the first information post.

A popularity level of the user account associated with the first information post may be increased (714). In some implementations, the popularity level of the user may be based upon or equivalent to the total number of social currency points the first user has “earned” via the social networking web site. By receiving a number of social currency points in relation to the re-post operation, for example, the popularity level of the user who originated the post may be increased through the re-posting of the information in the second discussion room. In some implementations, the popularity level of the user may be based upon the number of acquaintances and/or level of acquaintance between the user associated with the first information post and other users of the social networking web site. For example, based upon a new acquaintance generated via the re-post request, or an adjustment in acquaintance level between the user associated with the first information post and the user associated with the re-post request, the popularity level of the user may be increased.

The discussion room interface information may be re-generated (716) to include an indication of the second discussion room in relation to the first information post. In some implementations, the indication of the second discussion room may be presented adjacent to the first information post. In one example, the indication may include the name of the second discussion room. A graphical tally (e.g., “+2”), in another example, may be presented in relation to the first information post, indicating the number of additional discussion rooms containing the post. In one example, upon mouse-over or selection of the first information post, a listing of additional discussion rooms containing the post may be derived.

Although described in a particular order, the steps of the method 700 may in some implementations be performed in a different order, and in some examples the method 700 may include more or fewer steps. For example, in some implementations, the method 700 may include increasing an approval level associated with the first information post based in part upon the re-post request. In another example, a further step may include receiving an approval for the first information post from within the second discussion room, and crediting social currency points to both the originating user and the user who re-posted the content in relation to the approval (e.g., not necessarily in equal amounts).

In some implementations, since the user may not have had any control over the re-posting of the information, any disapprovals received in relation to the re-posting in the second discussion room may not reflect upon the originating user. For example, if the user who re-posted the information chose a poor location for re-posting the information, the disapproval may only reflect upon the popularity status of the user who re-posted the information.

Although described in relation to a “post,” in this context a post may include both a user information post and a user-initiated event.

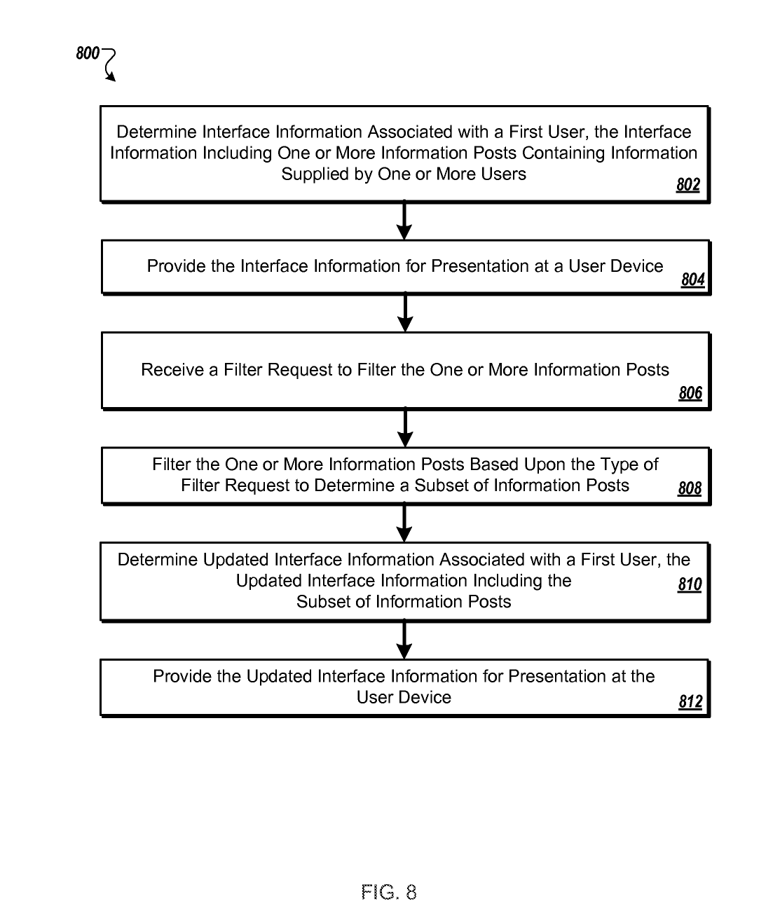

FIG. 8 is a flow chart of an example method 800 for filtering information posts provided for display in a user interface. The method 800 may begin, in some implementations, with determining interface information associated with a first user (802). The interface information, for example, may include one or more information posts containing information supplied by one or more users. For example, the interface information may be generated in a manner similar to that described in relation to step 406 of the flow chart 400 illustrated in FIG. 4.

The interface information may be provided (804) for presentation at a user device. For example, discussion room interface presentation may be achieved in a manner similar to that described in relation to step 408 of the flow chart 400 illustrated in FIG. 4. The presentation of the discussion room interface, in some implementations, may include a number of controls that, when selected, may provide the user with the opportunity to filter the interface information. In a first example, a control for filtering interface information may include a geographic location input control, providing the user with a method for selecting a geographic location, region, or range. In a second example, a time period input control may provide the user with the opportunity to narrow the information to a particular period of time (e.g., when information was first posted within the discussion room). An acquaintance tier selection control, in a third example, may provide the user with the option to filter the information presented by level of acquaintance with users who have interacted with the information (e.g., user who posted the information, user who responded to the information, user who promoted the information, user who re-posted the information, etc.). As a fourth example, an interest level input control may provide the user with the opportunity to filter the presented information based upon a relative interest level of the information in relation to other information presented within the discussion room. Other filtering options are possible.

In some implementations, a filter request to filter the one or more information posts may be received (806). For example, the user may initiate a filter request through selection of one or more filter controls. In another example, information may be filtered through key word search via a search query input box.

In some implementations, the one or more information posts may be filtered based upon the type of filter request (808). Filtering of the one or more information posts, for example, may result in determining a subset of information posts.

In some implementations, updated interface information, including the subset of information posts, may be determined (810). For example, discussion room interface information may be re-generated based upon the results of the filtering operation.

In some implementations, the updated interface information may be provided for presentation at the user device (812). For example, discussion room interface presentation may be achieved in a manner similar to that described in relation to step 408 of the flow chart 400 illustrated in FIG. 4.

Although described in a particular order, the steps of the method 800 may in some implementations be performed in a different order, and in some examples the method 800 may include more or fewer steps. For example, in some implementations, the method 800 may begin with filtering one or more information posts based in part upon default user preferences, prior to providing the interface information for presentation (804). Further to this example, in some implementations, it may be possible to later select a filtering operation that in fact adds different or additional information posts to the presentation. For example, a user may default to only reviewing information presented within the past three days. If a user requests information filtered to review information posts presented in the prior week, an entirely different set of information posts may be served to the user when the updated interface information is provided for presentation at the user device (812).

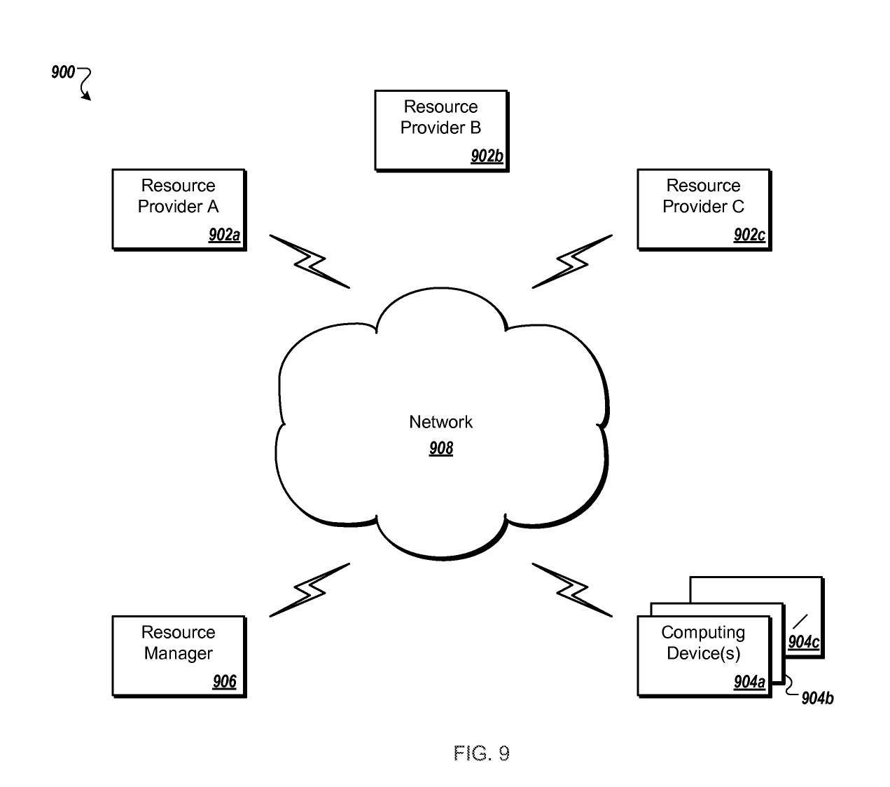

As shown in FIG. 9, an implementation of a network environment 900 for promotion via social currency is shown and described. In brief overview, referring now to FIG. 9, a block diagram of an exemplary cloud computing environment 900 is shown and described. The cloud computing environment 900 may include one or more resource providers 902a, 902b, 902c (collectively, 902). Each resource provider 902 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 902 may be connected to any other resource provider 902 in the cloud computing environment 900. In some implementations, the resource providers 902 may be connected over a computer network 908. Each resource provider 902 may be connected to one or more computing device 904a, 904b, 904c (collectively, 904), over the computer network 908.

The cloud computing environment 900 may include a resource manager 906. The resource manager 906 may be connected to the resource providers 902 and the computing devices 904 over the computer network 908. In some implementations, the resource manager 906 may facilitate the provision of computing resources by one or more resource providers 902 to one or more computing devices 904. The resource manager 906 may receive a request for a computing resource from a particular computing device 904. The resource manager 906 may identify one or more resource providers 902 capable of providing the computing resource requested by the computing device 904. The resource manager 906 may select a resource provider 902 to provide the computing resource. The resource manager 906 may facilitate a connection between the resource provider 902 and a particular computing device 904. In some implementations, the resource manager 906 may establish a connection between a particular resource provider 902 and a particular computing device 904. In some implementations, the resource manager 906 may redirect a particular computing device 904 to a particular resource provider 902 with the requested computing resource.

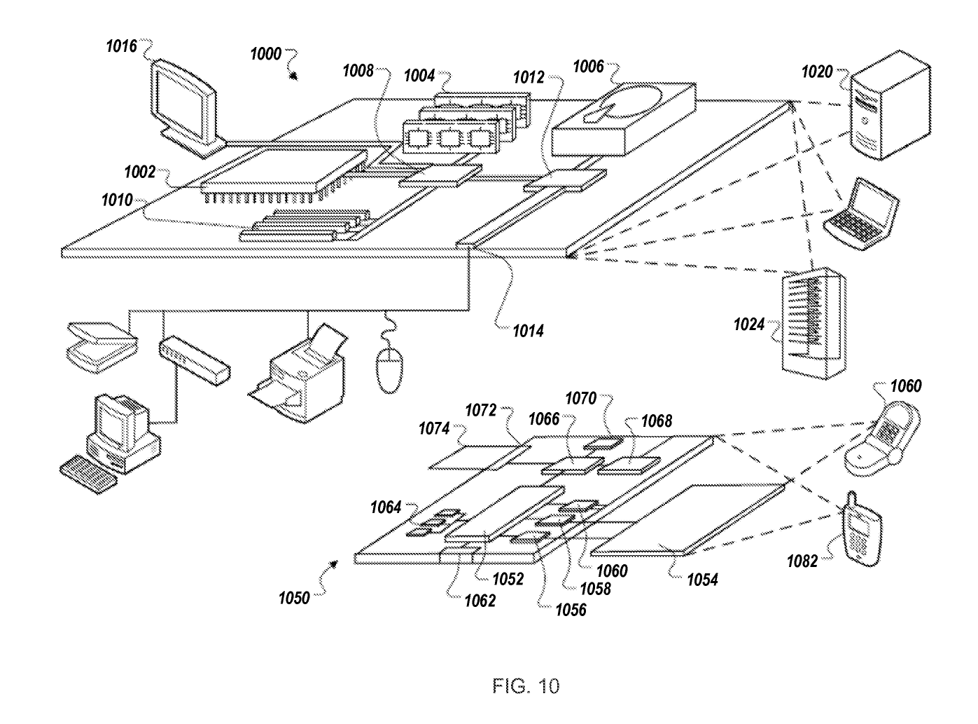

FIG. 10 shows an example of a computing device 1000 and a mobile computing device 1050 that can be used to implement the techniques described in this disclosure. The computing device 1000 is intended to represent various forms of digital computers, such as laptops, desktops, workstations, personal digital assistants, servers, blade servers, mainframes, and other appropriate computers. The mobile computing device 1050 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1000 includes a processor 1002, a memory 1004, a storage device 1006, a high-speed interface 1008 connecting to the memory 1004 and multiple high-speed expansion ports 1010, and a low-speed interface 1012 connecting to a low-speed expansion port 1014 and the storage device 1006. Each of the processor 1002, the memory 1004, the storage device 1006, the high-speed interface 1008, the high-speed expansion ports 1010, and the low-speed interface 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as a display 1016 coupled to the high-speed interface 1008. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1004 stores information within the computing device 1000. In some implementations, the memory 1004 is a volatile memory unit or units. In some implementations, the memory 1004 is a non-volatile memory unit or units. The memory 1004 may also be another form of computer-readable medium, such as a magnetic or optical disk.

The storage device 1006 is capable of providing mass storage for the computing device 1000. In some implementations, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1002), perform one or more methods, such as those described above. The instructions can also be stored by one or more storage devices such as computer- or machine-readable mediums (for example, the memory 1004, the storage device 1006, or memory on the processor 1002).

The high-speed interface 1008 manages bandwidth-intensive operations for the computing device 1000, while the low-speed interface 1012 manages lower bandwidth-intensive operations. Such allocation of functions is an example only. In some implementations, the high-speed interface 1008 is coupled to the memory 1004, the display 1016 (e.g., through a graphics processor or accelerator), and to the high-speed expansion ports 1010, which may accept various expansion cards (not shown). In the implementation, the low-speed interface 1012 is coupled to the storage device 1006 and the low-speed expansion port 1014. The low-speed expansion port 1014, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. In addition, it may be implemented in a personal computer such as a laptop computer 1022. It may also be implemented as part of a rack server system 1024. Alternatively, components from the computing device 1000 may be combined with other components in a mobile device (not shown), such as a mobile computing device 1050. Each of such devices may contain one or more of the computing device 1000 and the mobile computing device 1050, and an entire system may be made up of multiple computing devices communicating with each other.

The mobile computing device 1050 includes a processor 1052, a memory 1064, an input/output device such as a display 1054, a communication interface 1066, and a transceiver 1068, among other components. The mobile computing device 1050 may also be provided with a storage device, such as a micro-drive or other device, to provide additional storage. Each of the processor 1052, the memory 1064, the display 1054, the communication interface 1066, and the transceiver 1068, are interconnected using various buses, and several of the components may be mounted on a common motherboard or in other manners as appropriate.

The processor 1052 can execute instructions within the mobile computing device 1050, including instructions stored in the memory 1064. The processor 1052 may be implemented as a chipset of chips that include separate and multiple analog and digital processors. The processor 1052 may provide, for example, for coordination of the other components of the mobile computing device 1050, such as control of user interfaces, applications run by the mobile computing device 1050, and wireless communication by the mobile computing device 1050.

The processor 1052 may communicate with a user through a control interface 1058 and a display interface 1056 coupled to the display 1054. The display 1054 may be, for example, a TFT (Thin-Film-Transistor Liquid Crystal Display) display or an OLED (Organic Light Emitting Diode) display, or other appropriate display technology. The display interface 1056 may include appropriate circuitry for driving the display 1054 to present graphical and other information to a user. The control interface 1058 may receive commands from a user and convert them for submission to the processor 1052. In addition, an external interface 1062 may provide communication with the processor 1052, so as to enable near area communication of the mobile computing device 1050 with other devices. The external interface 1062 may provide, for example, for wired communication in some implementations, or for wireless communication in other implementations, and multiple interfaces may also be used.

The memory 1064 stores information within the mobile computing device 1050. The memory 1064 can be implemented as one or more of a computer-readable medium or media, a volatile memory unit or units, or a non-volatile memory unit or units. An expansion memory 1074 may also be provided and connected to the mobile computing device 1050 through an expansion interface 1072, which may include, for example, a SIMM (Single In Line Memory Module) card interface. The expansion memory 1074 may provide extra storage space for the mobile computing device 1050, or may also store applications or other information for the mobile computing device 1050. Specifically, the expansion memory 1074 may include instructions to carry out or supplement the processes described above, and may include secure information also. Thus, for example, the expansion memory 1074 may be provide as a security module for the mobile computing device 1050, and may be programmed with instructions that permit secure use of the mobile computing device 1050. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. The instructions, when executed by one or more processing devices (for example, processor 1052), may perform one or more methods, such as those described above. The instructions can also be stored by one or more storage devices, such as one or more computer- or machine-readable mediums (for example, the memory 1064, the expansion memory 1074, or memory on the processor 1052). In some implementations, the instructions can be received in a propagated signal, for example, over the transceiver 1068 or the external interface 1062.

The mobile computing device 1050 may communicate wirelessly through the communication interface 1066, which may include digital signal processing circuitry where necessary. The communication interface 1066 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1068 using a radio-frequency. In addition, short-range communication may occur, such as using a Bluetooth, WiFi, or other such transceiver (not shown). In addition, a GPS (Global Positioning System) receiver module 1070 may provide additional navigation- and location-related wireless data to the mobile computing device 1050, which may be used as appropriate by applications running on the mobile computing device 1050.

The mobile computing device 1050 may also communicate audibly using an audio codec 1060, which may receive spoken information from a user and convert it to usable digital information. The audio codec 1060 may likewise generate audible sound for a user, such as through a speaker, e.g., in a handset of the mobile computing device 1050. Such sound may include sound from voice telephone calls, may include recorded sound (e.g., voice messages, music files, etc.) and may also include sound generated by applications operating on the mobile computing device 1050.

The mobile computing device 1050 may be implemented in a number of different forms, as shown in the figure. For example, it may be implemented as a cellular telephone 1080. It may also be implemented as part of a smart-phone 1082, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system for promotion via social currency is provided. Having described certain implementations of methods and systems for promotion via social currency, it will now become apparent to one of skill in the art that other implementations incorporating the concepts of the disclosure may be used. Therefore, the disclosure should not be limited to certain implementations, but rather should be limited only by the spirit and scope of the following claims.

What is claimed:

1. A method comprising:
determining, by a processor of a computing device, for presentation to a first user as a user interface at a user computing device, interface information comprising a plurality of information posts, wherein:
each information post of the plurality of information posts is associated with a respective interest level,
the plurality of information posts are arranged for presentation in a ranked order based in part upon the respective interest level of each information post of the plurality of information posts, and
a first user account is associated with the first user;
providing the interface information for presentation at the user computing device;
receiving, via the user computing device, an indication of a user interaction associated with a first information post of the plurality of information posts, wherein
the first information post is associated with a second user account of a second user; and
responsive to receiving the indication of the user interaction:
debiting, by the processor, a first point value from a plurality of points associated with the first user account,
crediting, by the processor, a second point value to a plurality of points associated with the second user account,
creating, by the processor, an association between the first user account and the second user account, and
adjusting, by the processor, the respective interest level associated with the first information post.

2. The method of claim 1, further comprising:
responsive to receiving the indication of the user interaction, crediting, by the processor, a third point value to a plurality of event points associated with first user account, wherein
the event points associated with the first user account are applicable in registration for an event advertised via a web site, and
the first user account is registered to the web site.

3. The method of claim 1, wherein:
the plurality of information posts comprise event information; and
the interaction comprises registration information;
the method further comprising:
adjusting, by the processor, an attendance level of the first information post.

4. The method of claim 3, further comprising:
receiving, via the user device, a first location indicator comprising a geographic location; and
filtering, by the processor, a plurality of information post identifiers to select the plurality of information posts, wherein:
each information post identifier of the plurality of information post identifiers identifies a respective information post of the plurality of information posts, and
each information post of the plurality of information posts is selected based in part upon the first location indicator.

5. The method of claim 4, wherein:
the geographic location comprises at least one of a city, a metropolitan area, a state, a province, a territory, and a country.

6. The method of claim 1, wherein:
the user interface is associated with a first portion of a web site;
the first portion of the web site is associated with a first topic category;
the interaction comprises a re-post indication comprising a second topic category, wherein
a second portion of the web site is associated with the second topic category; and
wherein the method further comprises creating a logical link between the first information post and the second portion of the web site.

7. The method of claim 6, wherein the second portion of the web site is a news room interface, wherein:
the news room interface comprises a plurality of articles, wherein one or more articles of the plurality of articles relate to one or more portions of the web site; and
a first article of the plurality of articles comprises the re-post of the first information post, wherein the first article is associated with the second user.

8. The method of claim 1, further comprising:
receiving, via the user device, a timeframe indicator;
filtering, by the processor, a plurality of information post identifiers to select the plurality of information posts, wherein
the plurality of information post identifiers comprise one or more information identifiers identifying each of the plurality of information posts, and
each information post of the plurality of information posts is selected based in part on a comparison of a respective timestamp of each information post of the plurality of information posts to a time period associated with the timeframe indicator.

9. The method of claim 1, wherein the interaction is a response to the first information post, the method further comprising:
determining, by the processor, for presentation as a second user interface, second interface information, wherein
the second interface information comprises the first information post and a response post, wherein the response post comprises a portion of the response information,
the first information post is configured to be presented within a first column of the second user interface, and
the response post is configured to be presented within a second column of the second user interface, wherein the second column is configured to be presented adjacent to the first column; and
providing the second interface information for presentation at the user computing device.

10. The method of claim 1, further comprising:
responsive to receiving the indication of the user interaction, crediting, by the processor, a third point value to a plurality of self-promotion points associated with first user account, wherein
the self-promotion points associated with the first user account are applicable in promoting an information post comprising content created by the first user.

11. The method of claim 1, further comprising:
adjusting, by the processor, a popularity level associated with the first user account, wherein the popularity level is based in part upon a number of associations between the first user account and one or more other user accounts.

12. A system comprising:
a processor; and
a memory storing instructions thereon, wherein the instructions when executed cause the processor to:
determine, for presentation to a first user as a user interface at a user computing device, interface information comprising a plurality of information posts, wherein:
each information post of the plurality of information posts is associated with a respective interest level,
the plurality of information posts are arranged for presentation in a ranked order based in part upon the respective interest level of each information post of the plurality of information posts, and
a first user account is associated with the first user;
provide the interface information for presentation at the user computing device;
receive, via the user computing device, a user interaction associated with a first information post of the plurality of information posts, wherein
the first information post is associated with a second user account of a second user; and
responsive to the user interaction:
debit a first point value from a plurality of points associated with the first user account,
credit a second point value to a plurality of points associated with the second user account,
create an association between the first user account and the second user account, and
adjust the respective interest level associated with the first information post.

13. The system of claim 12, wherein the processor comprises a plurality of processors in communication via a network.

14. The system of claim 12, wherein:
creating the association between the first user account and the second user account comprises adjusting a level of acquaintance between the first user a second user, wherein
the level of acquaintance is based in part upon a number of times the first user has initiated interactions with information posts associated with the second user; and
the second account is registered to the second user.

15. The system of claim 14, wherein the level of acquaintance is further based in part upon a number of times the second user has initiated interactions with information posts associated with the first user.

16. The system of claim 14, wherein the ranked order is based further in part upon a respective acquaintance level between the first user and a respective user associated with each information post of the plurality of information posts.

17. A non-transitory computer readable medium having instructions thereon that, when executed, perform operations comprising:
determining, for presentation to a first user as a user interface at a user computing device, interface information comprising a plurality of information posts, wherein:
each information post of the plurality of information posts is associated with a respective interest level,
the plurality of information posts are arranged for presentation in a ranked order based in part upon the respective interest level of each information post of the plurality of information posts, and
a first user account is associated with the first user;
providing the interface information for presentation at the user computing device;
receiving, via the user computing device, a user interaction associated with a first information post of the plurality of information posts, wherein
the first information post is associated with a second user account of a second user; and
responsive to the user interaction:
debiting a first point value from a plurality of points associated with the first user account,
crediting a second point value to a plurality of points associated with the second user account,
creating an association between the first user account and the second user account, and
adjusting the respective interest level associated with the first information post.

18. The computer readable medium of claim 17, wherein:
the user interface is associated with a web page of a web site, wherein
the web page comprises a plurality of controls selectable for filtering information presented within the page, and
the plurality of controls comprise two or more of a time period filter, a geographic location filter, an interest level filter, and an acquaintance level filter.

19. The computer readable medium of claim 18, wherein:
the acquaintance level filter is configured, upon selection, to filter a plurality of information post identifiers to select a second plurality of information posts, wherein
each information post identifier of the plurality of information post identifiers is associated with the web page, and
the acquaintance level filter is configured to filter the plurality of information post identifiers based in part upon an acquaintance level between the first user and a respective user associated with the respective information post identifier of the plurality of information post identifiers.

20. The computer readable medium of claim 18, wherein:
the interest level filter is configured, upon selection, to filter a plurality of information post identifiers to select a second plurality of information posts, wherein
each information post of the second plurality of information posts is selected based in part upon the respective interest level of the respective information post, and
the interest level filter is associated with a range of interest levels comprising the respective interest level.
